(19) United States
(12) Patent Application Publication
(10) Pub. No.: US 2024/0304840 A1
(43) Pub. Date: Sep. 12, 2024

(54) Methods and Systems for Reducing Crossover in Redox Flow Batteries

(71) Applicant: XL Batteries, Inc., Marlborough, MA (US)

(72) Inventors: Thomas Sisto, Marlborough, MA (US); Anouck Champsaur, Marlborough, MA (US); Paul Evans, Marlborough, MA (US); Anthony Bencivenga, Marlborough, MA (US)

(73) Assignee: XL Batteries, Inc., Marlborough, MA (US)

(21) Appl. No.: 18/593,771

(22) Filed: Mar. 1, 2024

Related U.S. Application Data
(60) Provisional application No. 63/488,367, filed on Mar. 3, 2023.

(51) Int. Cl. H01M 8/04082; H01M 8/08; H01M 8/18

(52) U.S. Cl. CPC H01M 8/04197; H01M 8/08; H01M 8/188; H01M 2300/0005

(57) ABSTRACT

The disclosure provides redox flow batteries that have long-duration or long-lifetime for energy storage applications. The water-soluble perylene diimide based molecules can be used as energy storage materials in the anode chambers. The water-soluble ferrocene-based molecules can be used as energy storage materials in the cathode chambers. The redox flow batteries have negligible crossover rates across the membranes.

### CROSS-REFERENCE TO RELATED APPLICATIONS

The current disclosure claims the benefit under 35 U.S.C. § 119 (e) to U.S. Provisional Patent Application No. 63/488,367 entitled “Methods and Systems for Reducing Crossover in Redox Flow Batteries” filed Mar. 3, 2023. The disclosure of U.S. Provisional Patent Application No. 63/488,367 is hereby incorporated by reference in its entirety for all purposes.

### FIELD OF THE INVENTION

The present invention generally relates to methods and systems to reduce and prevent crossover of active species in redox flow batteries.

### BACKGROUND

Redox flow batteries include a few main components: tanks of electrolytes (catholytes and anolytes), electrochemical cells (for charging or discharging), membranes to separate the electrolyte solutions, and pumps to move electrolytes to the electrochemical cell and back into the tanks. One big challenge in a flow battery is the performance of the membrane that separates the catholyte and the anolyte. Separating the active components of the electrolytes from one another is critical to keeping charged components (and their neutral versions) in the appropriate tanks. If active species crossover occurs, capacity losses can be as high as 50% for flow batteries.

### BRIEF SUMMARY OF THE INVENTION

Summarized here and described in detail below are redox flow batteries that have negligible crossover rate. Many embodiments implement water soluble redox-active organic molecules including (but not limited to) perylene diimide derivatives as anolytes for the redox flow batteries. In several embodiments, one or both imide nitrogen(s) on the perylene diimide core are covalently bonded to a substituent that includes at least two cationic groups, or includes at least two anionic groups. Perylene diimide molecules with at least two cationic groups can be efficient at reducing crossover in redox flow batteries that use an anion-exchange membrane to separate the anode and cathode compartments. Some embodiments use cationic groups including (but not limited to) quaternary ammonium groups, imidazolium groups, and pyridinium groups, to modify perylene diimide. Perylene diimide molecules with at least two anionic groups can be efficient at reducing crossover in redox flow batteries that use a cation-exchange membrane to separate the anode and cathode compartments. A number of embodiments use anionic groups including (but not limited to) carboxylates, phosphonates, and sulfonate groups, to modify perylene diimide. Multiple cationic charges or anionic charges on the perylene diimide molecules in accordance with many embodiments can substantially minimize or prevent any crossover of the active species between the anode and cathode compartments of the battery.

Many embodiments implement water soluble and redox-active organic molecules in the catholyte solution in the cathode chamber. Examples of the redox-active molecules of the catholyte include (but are not limited to): ferrocene derivatives, TEMPO, ferrocyanide, iodine, or other catholyte materials. In some embodiments, the redox-active component of the catholyte solution comprises a water-soluble ferrocene-based compound. In certain embodiments, the ferrocene core is solubilized through attachment of an ionic scaffold comprising at least two ionic groups. Any common ionic group may be used to solubilize the ferrocene core, including (but not limited to) carboxylates, phosphonates, sulfonates, imidizoliums, pyridiniums, and thiazoliums. The ionic scaffold in accordance with some embodiments can contain (but not limited to) ammonium ions, carboxylate ions, and sulfonate ions. In a number of embodiments, the scaffold of the ferrocene-based compound comprises at least two cationic groups or at least two anionic groups. Ferrocene-based molecules with at least two cationic groups or at least two anionic groups can be efficient at reducing and minimizing crossover in redox flow batteries. TEMPO modified with at least two ionic solubilizing groups in accordance with some embodiments can reduce and/or minimize crossover in redox flow batteries under working conditions. Compared to the modified ferrocene and modified TEMPO, ferrocyanide and iodine have a much higher crossover rate as the two molecules lack the ionic solubilizing groups.

In many embodiments, the anolytes and the catholytes of redox flow batteries are aqueous electrolyte solutions of neutral and near neutral pH from about pH 5 to about pH 9; or from about pH 5.5 to about pH 8.5; or from about pH 6 to about pH 8; or from about pH 6.5 to about pH 7.5. The redox flow batteries in accordance with several embodiments exhibit negligible crossover rate under working conditions of the battery. In some embodiments, the redox flow batteries can be cycled for at least 90 days and the crossover rate of the redox molecules is less than about 0.1%; or less than about 0.05%; or less than about 0.02%; or less than about 0.01%; or less than about 0.005%; or less than about 0.001%; or less than about 0.0005%. In many embodiments, the redox flow batteries have a capacity retention of greater than about 99% over a period of at least 14 days. In several embodiments, the redox flow batteries have a capacity retention of greater than about 99.9% over a period of at least 14 days.

Some embodiments include a redox flow battery comprising: a first half-cell containing a first aqueous solution comprising a first electrode and an anolyte comprising a compound with a perylene diimide moiety wherein the perylene diimide moiety comprises at least two ionic groups; a second half-cell containing a second electrode and a second aqueous solution comprising a catholyte; and a separator interposed between the first half-cell and the second half cell; wherein less than 0.05% in concentration of the anolyte crosses over the separator to the second half-cell; and wherein less than 0.05% in concentration of the catholyte crosses over the separator to the first half-cell.

In some embodiments, the separator is a size exclusion membrane, or an ion exchange membrane.

In some embodiments, the separator is an anion exchange membrane or a cation exchange membrane.

In some embodiments, less than 0.001% in concentration of the anolyte crosses over the separator to the second half-cell, and wherein less than 0.001% in concentration of the catholyte crosses over the separator to the first half-cell.

In some embodiments, the compound has a Formula (I):

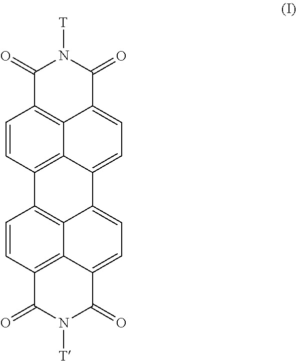

or a salt thereof, wherein:
T is -(L-G)ₙ-X;
T′ is H, (C₁-C₆)alkyl, or -(L-G)ₙ-X;
L is —(C₂-C₅)-alkyl optionally substituted with OH, OCH₃, halo

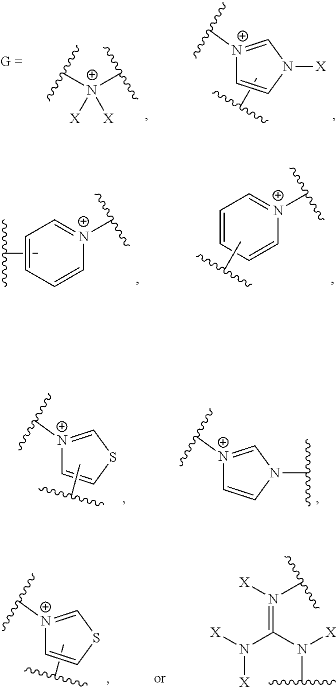

each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20.

In some embodiments, T and T′ are each independently -(L-G)ₙ-X.

In some embodiments, L is selected from the group consisting of: unsubstituted —(C₂-C₅)-alkyl, ethyl, and propyl.

In some embodiments, n is 2, 3, or 4.

In some embodiments, G is

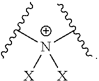

In some embodiments, X is H, methyl or —CH₂CH₂OH.

In some embodiments, each X is independently H or —(C₁-C₆)-alkyl.

In some embodiments, at least one X is —CH₃CH₂OH.

In some embodiments, the compound of Formula (I) is:

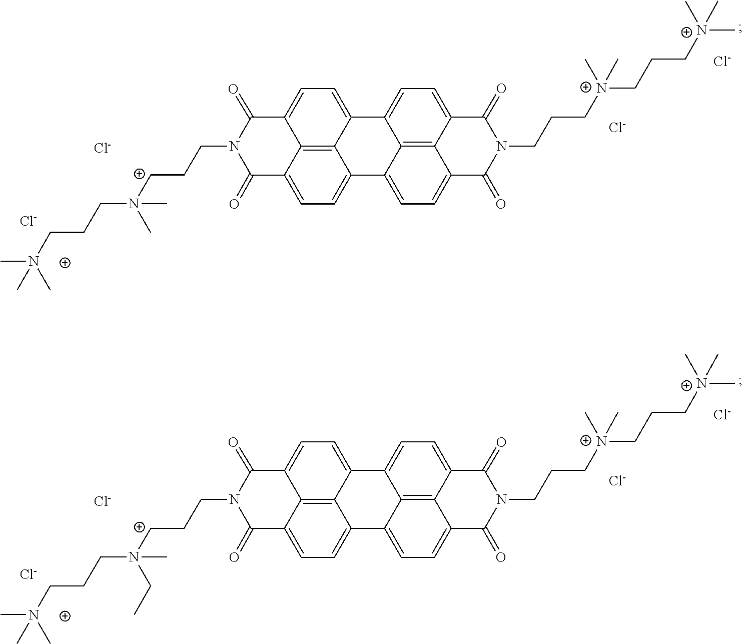

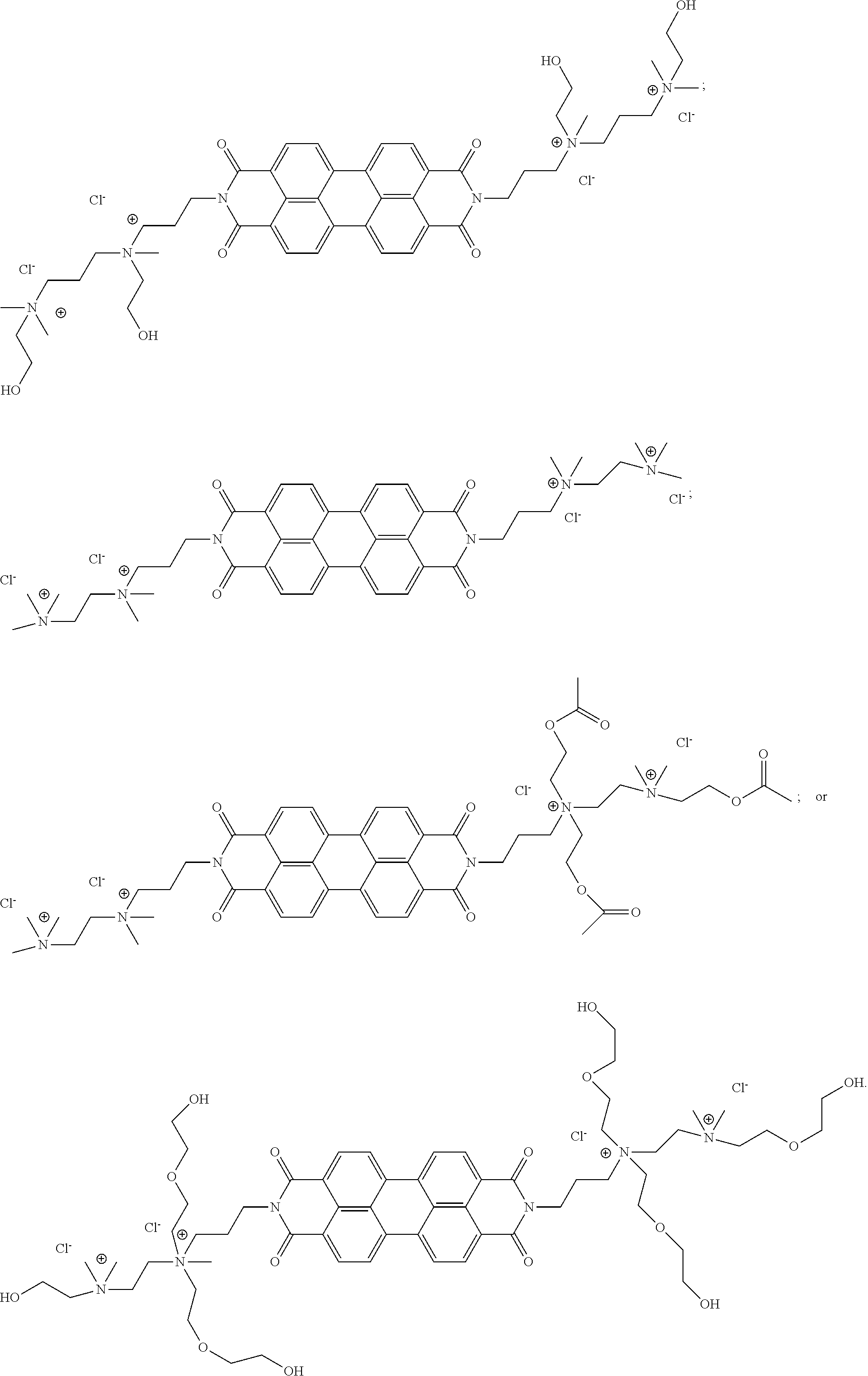

In some embodiments, the compound has a Formula (II):

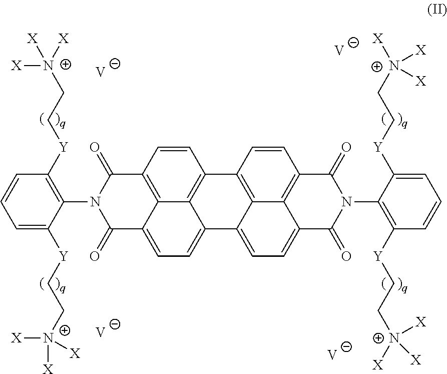

wherein
each Y is independently —O—, —S— or —NH—;
each q is independently 1 to 8; and
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂; and
each V is a counterion.

In some embodiments, the compound of Formula (II) is:

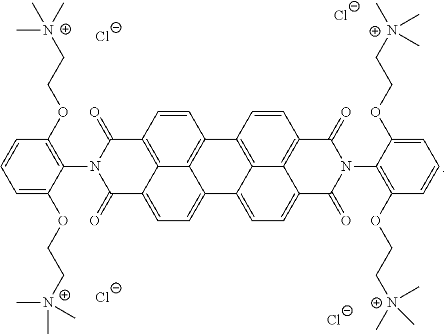 [SMILES: C[N+](C)(C)CCOc1cccc(OCC[N+](C)(C)C)c1N1C(=O)c2ccc3c4ccc5c6c(ccc(c7ccc(c2c37)C1=O)c64)C(=O)N(c1c(OCC[N+](C)(C)C)cccc1OCC[N+](C)(C)C)C5=O ; [Cl-] ; [Cl-] ; [Cl-] ; [Cl-]]

In some embodiments, the compound has a Formula (III):

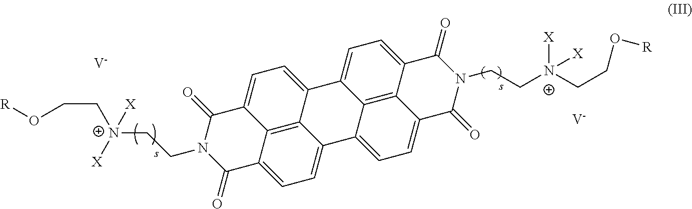

wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-6)alkyl; and
each V⁻ is a counterion.

In some embodiments, the compound of Formula (III) is:

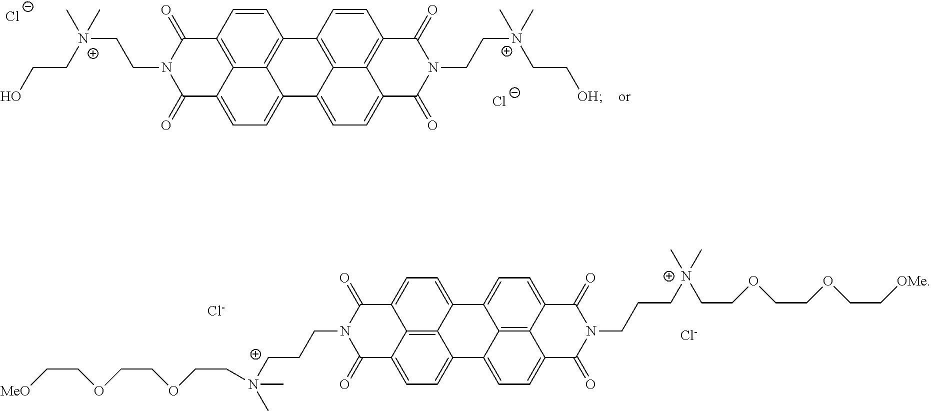

In some embodiments, the compound has a Formula (IV):

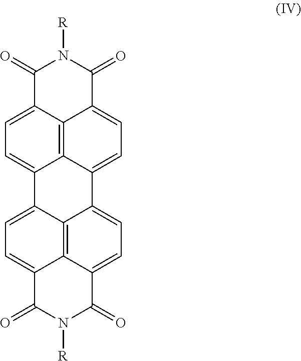

wherein
R is

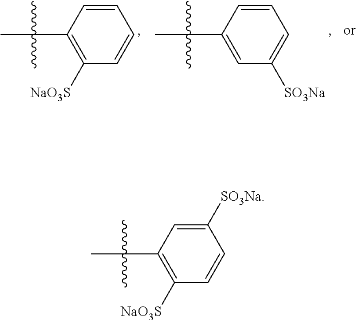

In some embodiments, the compound of Formula (IV) is

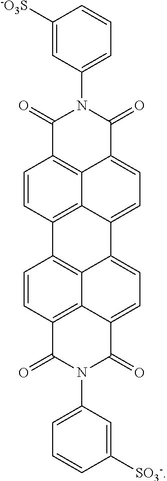

In some embodiments, the compound has a Formula (V):

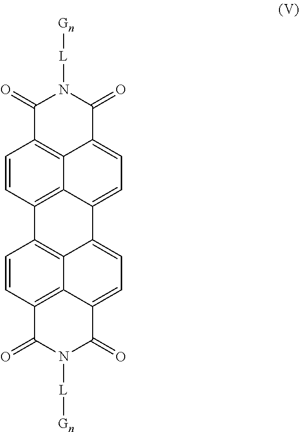

or a salt thereof, wherein
L is —(C₁-C₆)-alkyl;
each G is

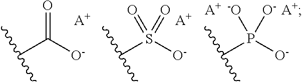

A is a cation; and
n=1 to 5.

In some embodiments, L is substituted with OH, OCH₃, and halo.
In some embodiments, each A is lithium, sodium, potassium, or ammonium.

In some embodiments, each G is

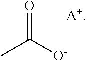

In some embodiments, each L is propyl.

In some embodiments, n is 2.

In some embodiments, L-Gₙ group has at least one chiral center.

In some embodiments, the formula (V) has at least one stereoisomer.

In some embodiments, the compound of Formula (V) is

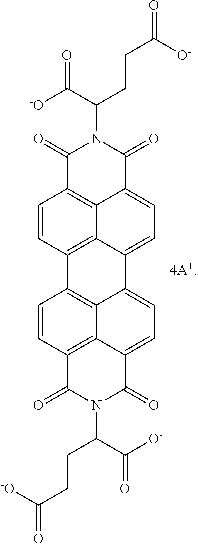

In some embodiments, the compound of Formula (V) is

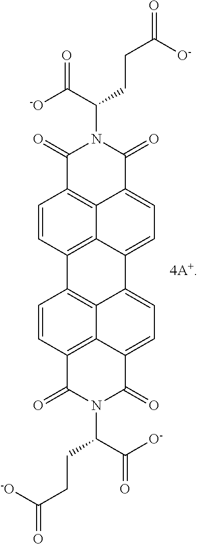

In some embodiments, the compound of Formula (V) is

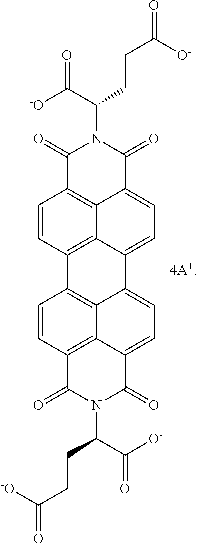

In some embodiments, the compound of Formula (V) is selected from the group consisting of:

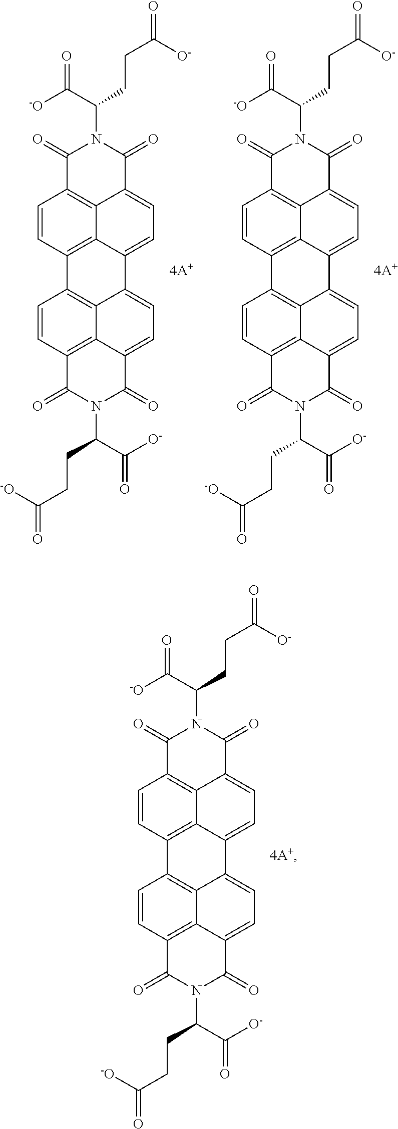

and any combinations thereof.

In some embodiments, A is lithium, sodium, potassium, or ammonium.

In some embodiments, the compound of Formula (V) is

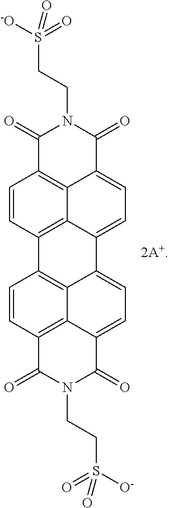

In some embodiments, the catholyte comprises a second compound with a ferrocene moiety.

In some embodiments, the second compound has a formula selected from the group consisting of:

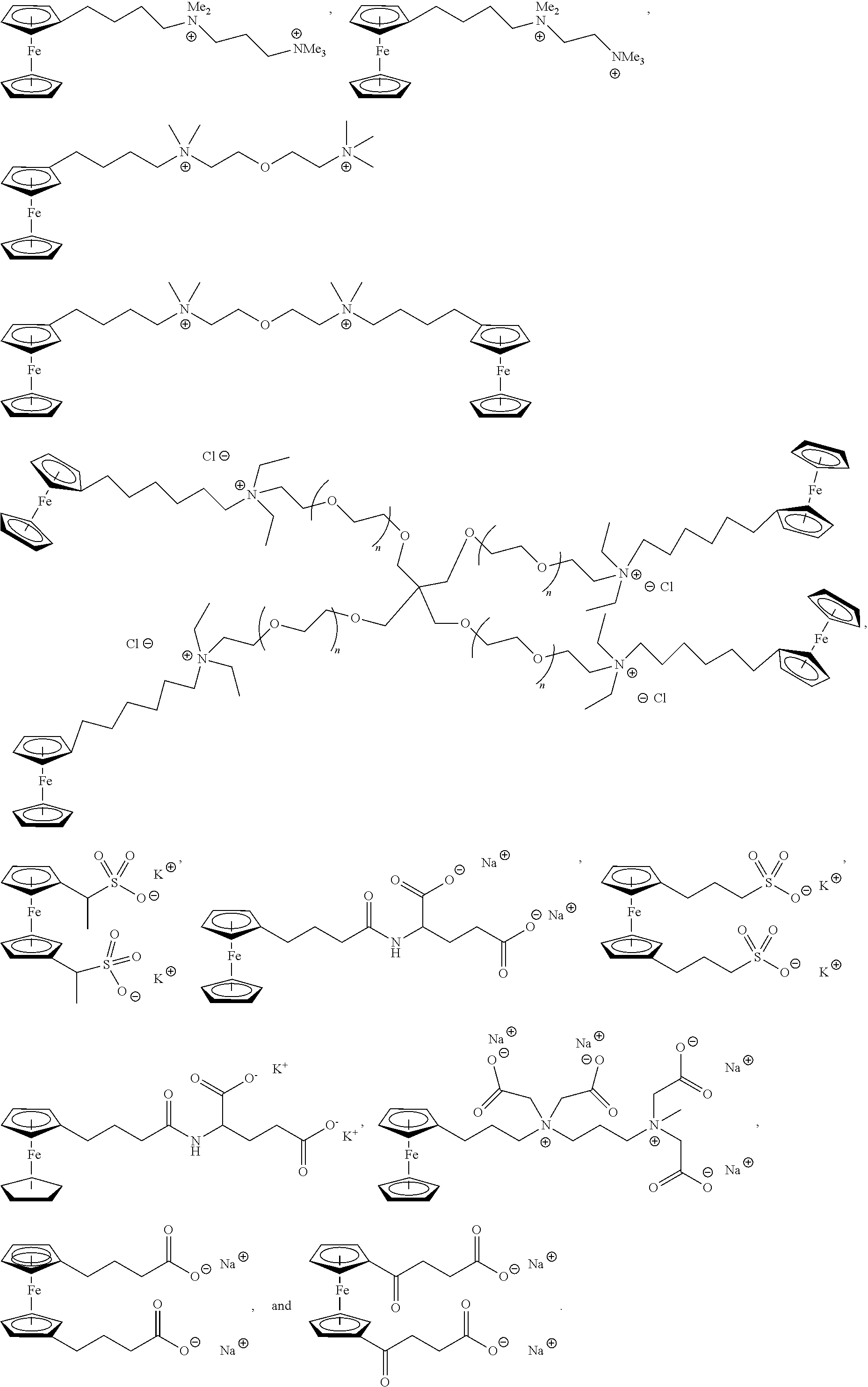

In some embodiments, the second compound has a Formula (VI):

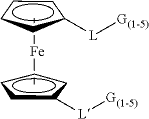

wherein:
L is —(C₁-C₁₀)-alkyl, —(C₁-C₆)-alkenyl, —(C1-C6)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl-(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
L′is —H, —(C₁-C₁₀)-alkyl, —(C₁-C₆)-alkenyl, —(C1-C6)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl-(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
G is selected from the group consisting of

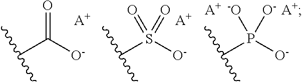

G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl.

In some embodiments, L is substituted by at least one group selected from the group consisting of: G, —OH, —OCH₃, and -halo.

In some embodiments, L′ is substituted at least one group selected from the group consisting of: G, —OH, —OCH₃, and -halo.

In some embodiments, R² is substituted by at least one G.

In some embodiments, L-Gₙ has at least one chiral center.

In some embodiments, the compound has at least one stereoisomer.

In some embodiments, the compound of Formula (VI) is

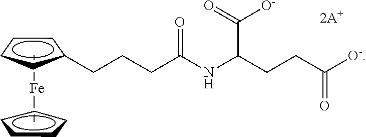

In some embodiments, the compound of Formula (VI) is

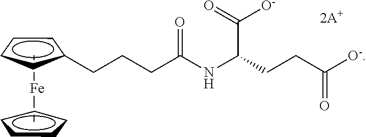

In some embodiments, the compound of Formula (VI) is

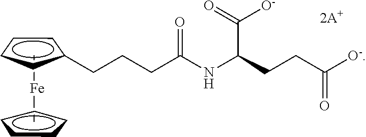

In some embodiments, the compound of Formula (VI) is selected from the group consisting of:

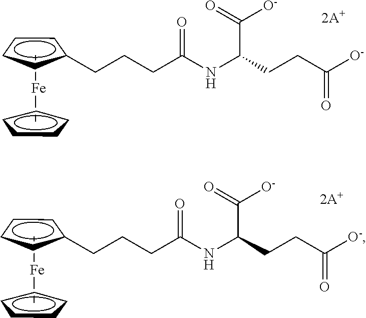

and any combination thereof.

In some embodiments, the compound of Formula (VI) is

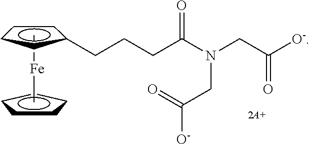

In some embodiments, the anolyte is perylene diimide-diammonium-Cl₂ and the catholyte is ferrocene-diammonium-Cl₂.

In some embodiments, the anolyte is perylene diimide-diammonium-Cl₂ and less than 0.0004% in concentration of the anolyte crosses over the separator to the second half-cell after cycling the redox flow battery for at least 90 days.

In some embodiments, the catholyte is ferrocene-diammonium-Cl₂ and less than 0.02% in concentration of the catholyte crosses over the separator to the first half-cell after cycling the redox flow battery for at least 90 days.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF FIGURES

The description will be more fully understood with reference to the following figures, which are presented as example embodiments of the invention and should not be construed as a complete recitation of the scope of the invention, wherein:

FIG. 1 illustrates a calibration curve exhibiting a detection limit of a perylene diimide derivative using UV-vis in accordance with an embodiment of the invention.

FIG. 2 illustrates a UV-vis spectrum of an aliquot from the analysis chamber of a crossover test, displaying less than about 0.00004% crossover of a perylene diimide derivative after 3 months in accordance with an embodiment of the invention.

FIG. 3 illustrates a calibration curve exhibiting a detection limit of a ferrocene derivative using UV-vis in accordance with an embodiment of the invention.

FIG. 4 illustrates a UV-vis spectrum of an aliquot from the analysis chamber of a crossover test, displaying less than about 0.002% crossover of a ferrocene derivative after 3 months in accordance with an embodiment of the invention.

FIG. 5 illustrates the flow crossover tests for Fc-MSG molecules in accordance with an embodiment of the invention.

FIG. 6 illustrates the flow crossover tests for Fc-BA molecules in accordance with an embodiment of the invention.

FIG. 7 illustrates charge and discharge capacity of a cycling cell of Fc-Ac-SO3Na and MSG-PDI and the observed capacity decay from crossover of Fc-Ac-SO3Na in accordance with an embodiment of the invention.

FIG. 8 illustrates HPLC spectra of a catholyte side and an anolyte side of an electrochemical cell using MSG-PDI and Fc-Ac-SO3Na and showing the crossover of catholyte into the anolyte chamber but no crossover of anolyte into the catholyte chamber, in accordance with an embodiment of the invention.

FIG. 9 illustrates stable coulombic efficiency of a 10 mAh flow cell demonstrating the resistance of the electrolyte molecules to membrane crossover in accordance with an embodiment of the invention.

FIG. 10 illustrates a redox flow battery in accordance with an embodiment of the invention.

### DETAILED DESCRIPTION

Turning now to the drawings, redox flow batteries with negligible crossover rate are described. Redox flow batteries can use a wide range of active materials to store energy. However, a number of simultaneous requirements need to be met to make chemistry attractive. One challenging requirement is minimizing transport of active species through the membrane separating the cathodes and the anodes, which minimizes the associated inefficiency and capacity loss. Redox flow batteries with appropriate active materials that can mitigate crossover can improve the battery performance (capacity) and durability (lifetime). The rate and impact of crossover depends on the nature of the active materials and their rate of transport across the separator and then subsequent behavior after that transport respectively.

Crossover is the unwanted process where a molecule of electrolyte diffuses across the membrane into the opposing chamber. The wandering electrolyte is quenched chemically or electrochemically if charged. Once crossed over, the electrolyte can no longer be used to store charge, which causes the capacity of the battery to fade in an unrecoverable way. This can also lead to degradation of the electrolyte solutions, as the opposing electrolytes are more likely to react and decompose when mixed together than if held separately. Redox flow batteries with high crossover rate can have the capacity fade and performance degrade drastically so as to limit the lifetime of the battery. To ensure the potential of long lifetimes and high capacities for flow batteries, crossover needs to be effectively eliminated.

The membrane of the redox flow battery is important for the proper function of the flow battery. Located in the electrochemical cell between the anode and the cathode, the membrane should allow the diffusion of certain ions to allow for charge balance to be maintained, but it should not allow the diffusion of any or some of the active charge storage electrolytes. There are two types of membranes to attempt to satisfy these requirements: size-exclusion membranes and ion-exchange membranes. Size-exclusion membranes are designed to have a distinct pore size that allow small molecules (charge carriers or solvents), such as protons or small ionic salts to pass through, but retain larger electrolytes. Size-exclusion membranes can be used for polymer electrolytes. Larger polymers may not be able to diffuse across size-exclusion membranes. Ion-exchange membranes are designed to allow the passage of molecules of one charge polarity while precluding the passage of molecules of the opposite polarity. In this way, charged electrolytes can be sequestered on the proper sides of the battery, but supporting ions of the opposite polarity can pass to balance the charge changes resulting from electron flow.

Many embodiments provide redox flow batteries with anolyte and catholyte molecules that have negligible membrane crossover. The redox flow batteries in accordance with some embodiments have long-duration or long-lifetime, and have negligible crossover rate for energy storage applications. In several embodiments, the water soluble perylene diimide molecules or perylene diimide-based molecules can be used as energy storage materials. In an anode chamber, molecules containing neutral perylene diimide cores in accordance with some embodiments can be reduced during charging to store energy, and the reduced form is then oxidized during discharge to release energy. Respectively in a cathode chamber, electrons are released from a charge storage material in an oxidation process during charging to store energy, wherein they are then reduced during discharging to release energy. Several embodiments implement ferrocene or ferrocene-based molecules as the cathode charge storage material.

In several embodiments, one or both imide nitrogen(s) on the perylene diimide core can be covalently bonded to a substituent that includes at least two cationic groups. In several embodiments, the perylene diimide molecules can be modified with at least two cationic groups; or at least three cationic groups; or at least four cationic groups; or at least five cationic groups. The multiple cationic groups on the perylene diimide core can be the same or can be different. Examples of the cationic groups include (but are not limited to) quaternary ammonium groups, imidazolium groups, and pyridinium groups. Many embodiments provide that perylene diimide molecules with less than two cationic groups have a higher crossover rate than the perylene diimide molecules with at least two cationic groups. Perylene diimide molecules modified with at least two cationic groups in accordance with some embodiments can be useful for redox flow batteries that use an anion-exchange membrane to separate the anode and cathode compartments. Many embodiments provide that the addition of at least two cationic charges on the perylene diimide molecules can minimize and/or prevent any crossover between the anode and cathode compartments of the battery. In some embodiments, the anolyte molecule can include multiple positive charges to limit crossover between the cathode chamber and the anode chamber.

In many embodiments, one or both imide nitrogens on the perylene diimide core can be covalently bonded to a substituent that includes at least two anionic groups. In some embodiments, the perylene diimide molecules can be modified with at least two anionic groups; or at least three anionic groups; or at least four anionic groups; or at least five anionic groups. The multiple anionic groups on the perylene diimide core can be the same or can be different. Examples of the anionic groups include (but are not limited to) carboxylates, phosphonates, and sulfonate groups. Many embodiments provide that perylene diimide molecules with less than two anionic groups have a higher crossover rate than the perylene diimide molecules with at least two anionic groups. Perylene diimide molecules modified with at least two anionic groups in accordance with certain embodiments can be useful for redox flow batteries that use a cation-exchange membrane to separate the anode and cathode compartments. Several embodiments provide that the addition of at least two anionic charges on the perylene diimide molecules can minimize and/or prevent any crossover between the anode and cathode compartments of the battery. In some embodiments, the anolyte molecule can include multiple negative charges to limit crossover between the cathode chamber and the anode chamber.

The anolyte solutions of the redox flow batteries in accordance with many embodiments can comprise water soluble perylene diimide (PDI) molecules. The highly-conjugated, electron-poor core of PDI is readily and reversibly reduced to accept two electrons. For most purposes, perylene diimides with functionality at one or both of the imide nitrogen atoms are synthesized from perylene tetracarboxylicdianhydride (PD/1) by condensation with primary amines. In this way organic-soluble, water-soluble, polymeric and liquid-crystal perylene diimides have been developed, in which the choice of functional groups on one or both nitrogen atoms are covalently bound to groups that can modify the perylene diimide properties. Several embodiments provide that although these molecular modifications can modify certain perylene diimide properties, these modifications do not significantly impact the charge storage stability of the perylene diimides. Without being bound by theory, electron and frontier molecular orbital densities for the perylene diimide core are concentrated in the aromatic backbone, meaning that the redox properties of the N-functionalized perylene diimides are all identical in energy level, reversibility, and stability in solution regardless of the modifications. As a result, such molecular modifications do not influence charge storage stability.

In certain embodiments, the perylene diimide molecules used as anolytes include a perylene diimide redox core that is covalently bonded to a solubilizing group. In several embodiments, the perylene diimide core is solubilized through attachment of an ionic scaffold. Any common ionic group may be used to solubilize the perylene diimide core, such as but not limited to ammonium ions, carboxylates, phosphonates, sulfonates, imidizoliums, pyridiniums, and thiazoliums. In some embodiments, one or both nitrogen atoms of the perylene diimide core are covalently bonded to a quaternized aminoalkyl group. In certain embodiments, one or both nitrogen atoms of the perylene diimide core are covalently bonded to carboxylate groups.

The perylene diimide molecules in accordance with many embodiments are highly stable both in their charged and uncharged states. In some embodiments, the perylene diimides molecules show good stability in their 2-electron reduced states, even when present in high concentrations in the aqueous media. Additionally, the perylene diimide molecules are compatible with both ion-exchange and size-exclusion membranes as they show minimal crossover from the anode chamber into the cathode chamber.

Many embodiments provide that the perylene diimide molecules are water soluble. In certain embodiments, the anolyte solutions can include perylene diimide compounds dissolved in water without additional solvents. The perylene diimide compounds can be dissolved in (but not limited to) water, tap water or deionized water. In some embodiments, the anolyte solutions can include supporting electrolytes including (but not limited to) NaCl, KCl, NH₄Cl, Na₂SO₄, MgCl₂, or a mixture thereof. In certain embodiments, the anolyte solutions may include a co-solvent to increase the solubility of the perylene diimide compounds in the aqueous solution. Examples of co-solvents include (but are not limited to) methanol, propylene carbonate and ethylene glycol.

The perylene diimide molecules in accordance with several embodiments can be highly stable over a range of PH levels. In some embodiments, the anolyte solutions can be prepared with acidic, neutral or basic aqueous media. In a number of embodiments, the anolyte solutions can be prepared at a neutral pH (pH at about 7) or pH from about 6 to about 8; or pH from about 6.5 to about 7.5. Several embodiments prepare the anolyte solutions in a basic media. In such embodiments, the pH of the anolyte solutions can vary from about 7.5 to about 10. A number of embodiments prepare the anolyte solutions in an acidic media with pH of the anolyte solutions ranging from about 4 to about 6.5; or from about 5 to about 6.5. In some embodiments, the pH of the anolyte solutions can be neutral or close to neutral (pH ranging from about 5.5 to about 8.5). In several embodiments, the anolyte solutions can be prepared using tap water.

In various embodiments, the perylene diimide compounds can have the structure of Formula (I):

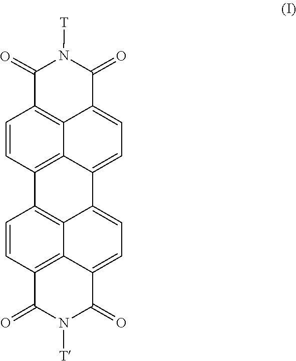

or a salt thereof, wherein:
T=-(L-G)ₙ-X;
T′=H, C₁₋₆alkyl, or -(L-G)ₙ-X;
L=—(C₂-C₅)-alkyl optionally substituted with OH, OCH₃, halo;

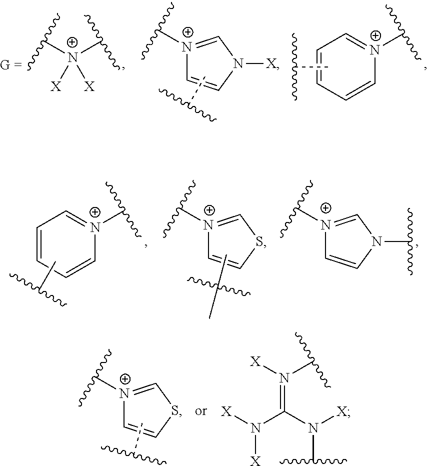

each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20.

In the compound of Formula (I), each L-G group of variable T can be the same or different. In some embodiments, if n equals to 2, each L can be ethyl. In certain embodiments, the first L group may be ethyl, and the second L group may be propyl. The G group of variable T can be the same or different in accordance with some embodiments. In some embodiments, if n equals to 2, each G group of L-G can be an ammonium group. In several embodiments, the first G group may be an ammonium group and the second G group may be a pyridinium group.

In some embodiments, the perylene diimide molecule of Formula (I) where the perylene diimide compounds can be symmetrical (i.e. T=T′). In certain embodiments, the perylene diimide compounds are unsymmetrical (i.e. T and T′ are not equivalent).

In several embodiments, the perylene diimide molecule of Formula (I), each L of L-G is ethyl or propyl.

In some embodiments, the perylene diimide molecule is a compound of Formula (I) where n can be 2. In several embodiments, the perylene diimide molecule is a compound of Formula (I) where n can be 3. In certain embodiments, the perylene diimide molecule is a compound of Formula (I) where n can be 4.

In many embodiments, the perylene diimide molecule of Formula (I) where L can be unsubstituted —(C₂-C₅)-alkyl. In certain embodiments, L can be unsubstituted ethyl. In some embodiments, L can be unsubstituted propyl.

In some embodiments, the perylene diimide molecule of Formula (I) where G can be

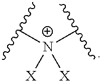

In several embodiments, each X can be H. In various embodiments, each X can be methyl. In certain embodiments, one X can be H and at least one other X can be methyl. In certain embodiments, at least one X can be —CH₂CH₂OH.

In some embodiments, the perylene diimide molecule of Formula (I) where each X can be independently H or —(C₁-C₆)-alkyl.

In a number of embodiments, the perylene diimide molecule of Formula (I) where at least one X can be —(C₁-C₆)-alkyl-OH. In some embodiments, at least one X can be —CH₃CH₂OH.

In many embodiments, the compound of Formula (I) has the following structure:

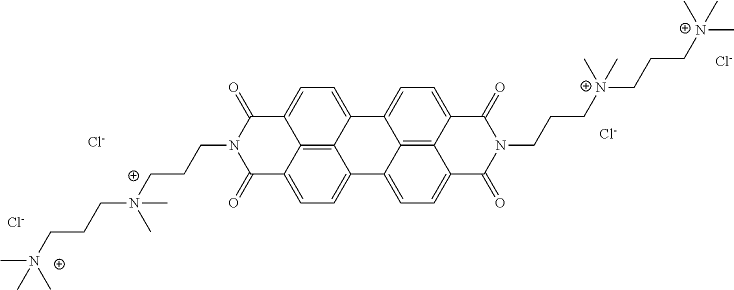

In certain embodiments, the compound of Formula (I) has the following structure:

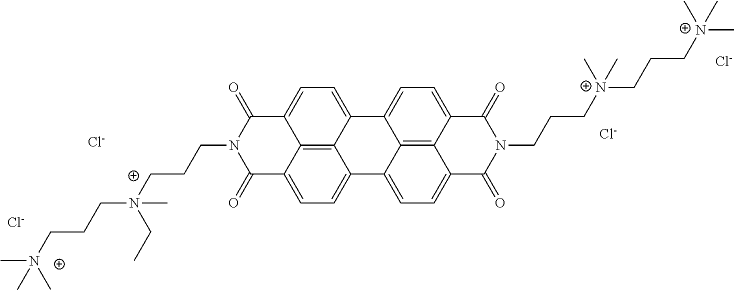

In some embodiments, the compound of Formula (I) has the following structure:

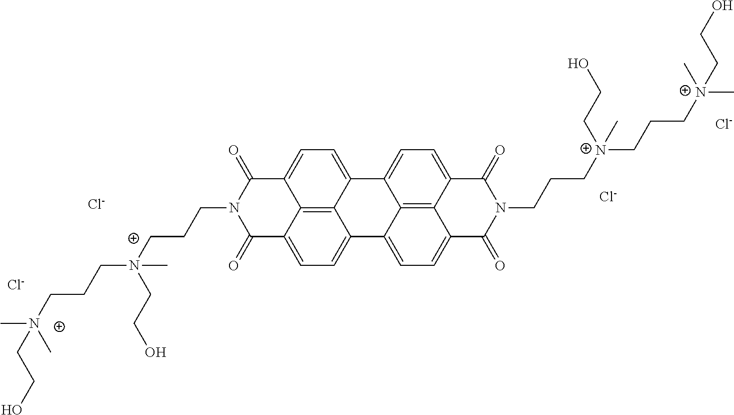

In several embodiments, the compound of Formula (I) has the following structure:

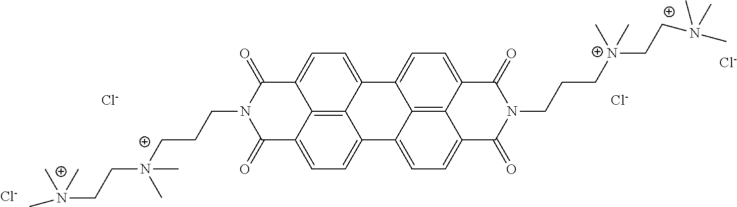

In many embodiments, the compound of Formula (I) has the following structure:

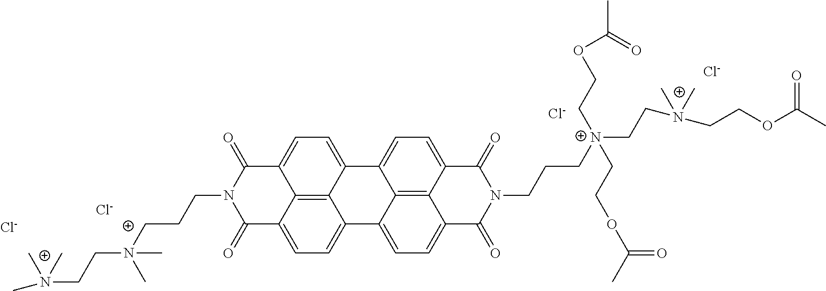

In some embodiments, the compound of Formula (I) has the following structure:

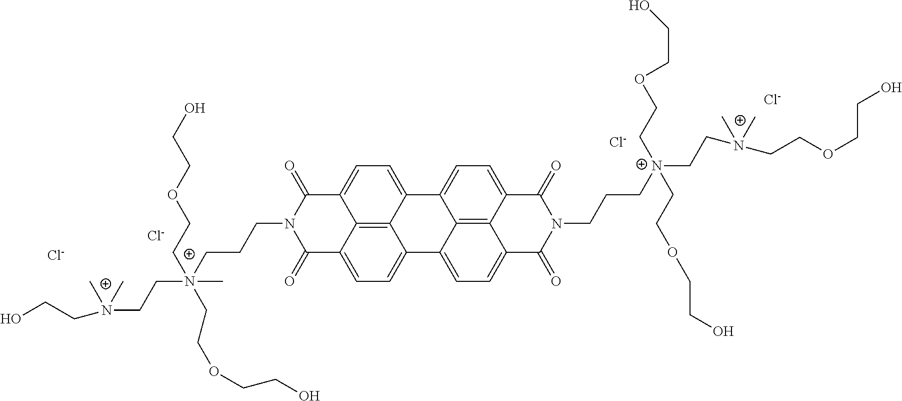

In a number of embodiments, the perylene diimide compounds have the structure of Formula (II):

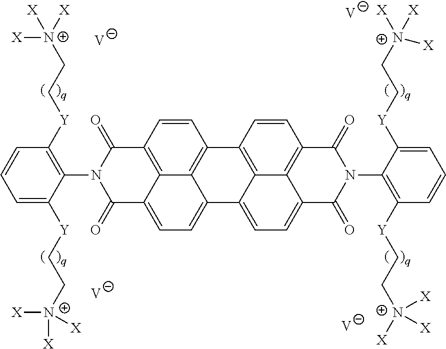

Wherein:
each Y is independently —O—, —S— or—NH—;
each q is independently 1 to 8; and
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂; and
each V is a counterion.

In some embodiments, the compound of Formula (II) has the following structure:

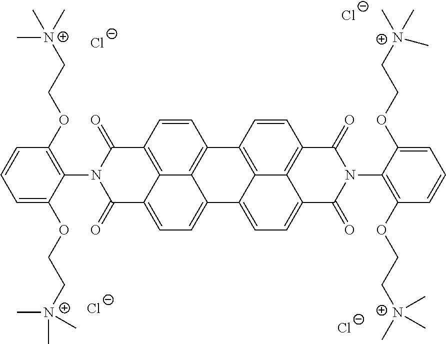 [SMILES: C[N+](C)(C)CCOc1cccc(OCC[N+](C)(C)C)c1N1C(=O)c2ccc3c4ccc5c6c(ccc(c7ccc(c2c37)C1=O)c64)C(=O)N(c1c(OCC[N+](C)(C)C)cccc1OCC[N+](C)(C)C)C5=O ; [Cl-] ; [Cl-] ; [Cl-] ; [Cl-]]

In various embodiments, the perylene diimide compounds have the structure of Formula (III):

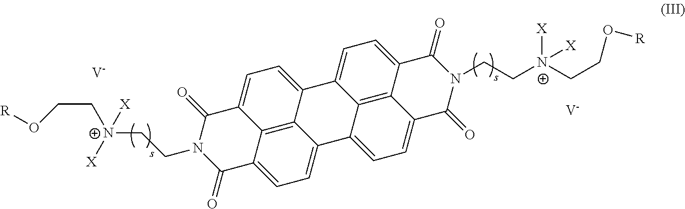

wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-C₆)alkyl; and
each V is a counterion.

In several embodiments, the compound of Formula (III) has the following structure:

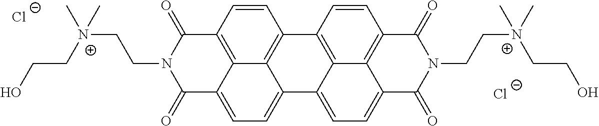 [SMILES: C[N+](C)(CCO)CCN1C(=O)c2ccc3c4ccc5c6c(ccc(c7ccc(c2c37)C1=O)c64)C(=O)N(CC[N+](C)(C)CCO)C5=O ; [Cl-] ; [Cl-]]

In some embodiments, the compound of Formula (III) has the following structure:

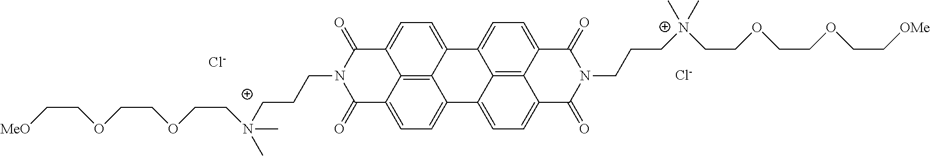

In certain embodiments, the perylene diimide compounds have the structure of Formula (IV):

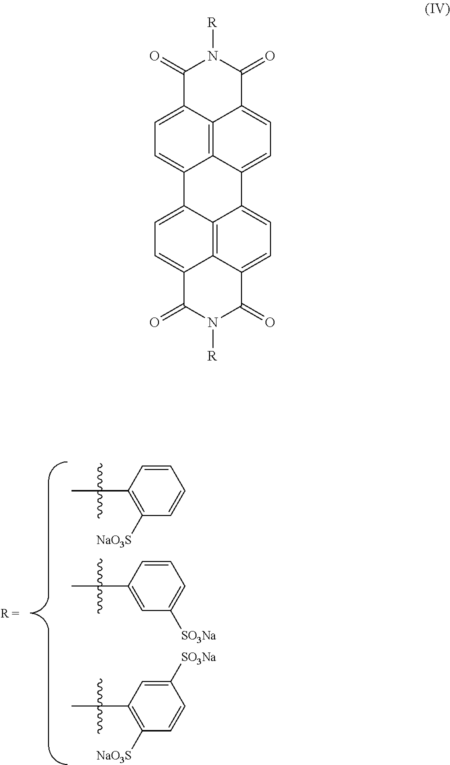

In some embodiments, the compound of Formula (IV) has the following structure:

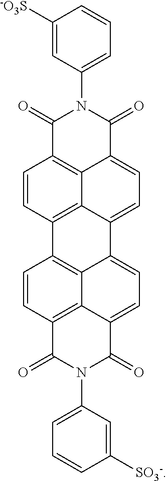

In some embodiments, the perylene diimide compounds have the structure of Formula (V):

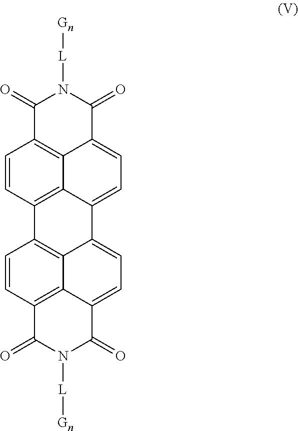

or a salt thereof, wherein:
each L is independently a —(C₁-C₆)-alkyl, optionally substituted with OH, OCH₃ and halo;
each G may be independently selected from

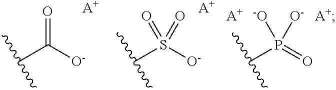

A is a cation; and
n=1 to 5.

In certain embodiments, A can be lithium, sodium, potassium, or ammonium in Formula (V).

In some embodiments, G can be

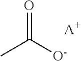

### in Formula (V).

In several embodiments, L can be propyl in Formula (V).

In certain embodiments, n can be 2 in Formula (V).

In certain embodiments, the L-Gₙ group may have one or more chiral centers. If that is the case, the resulting compound of Formula (V) may have several stereoisomers. In some embodiments, the compound may be a single stereoisomer. In other embodiments, the compound may be a mixture of two or more stereoisomers in any ratio. The mixture may comprise every stereoisomer of a compound, or it may exclude one or more. If no chirality is indicated at the stereocenter, then the compound may be comprised of any mixture of stereoisomers.

In many embodiments, the compound of Formula (V) can be:

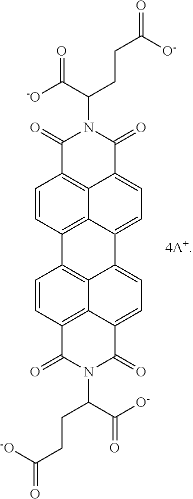

In certain embodiments, the compound of Formula (V) can be:

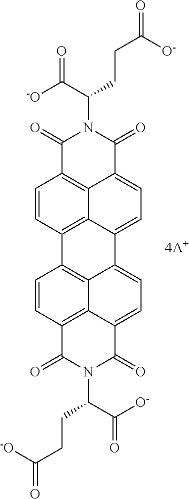

In certain embodiments, the compound of Formula (V) can be:

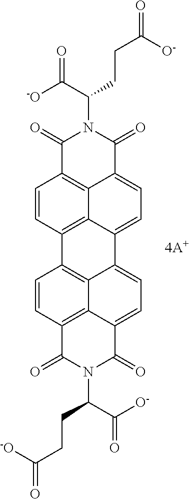

In certain embodiments, the compound of Formula (V) can be any mixture of the following stereoisomers:

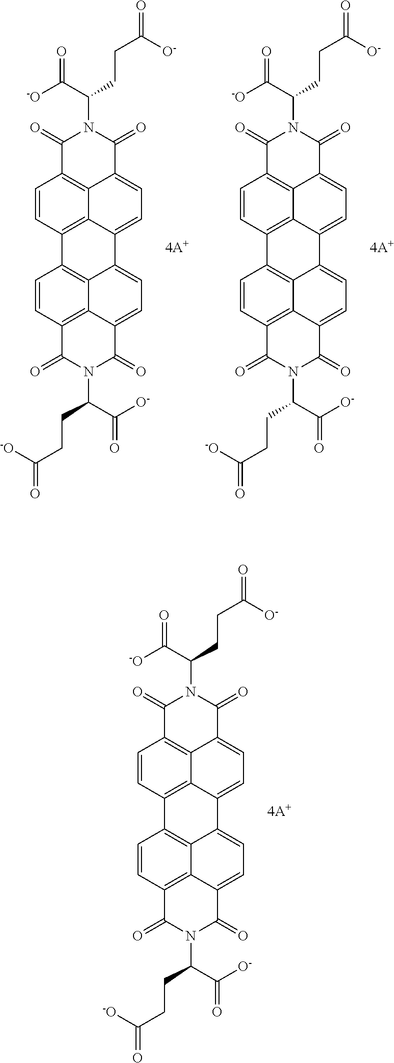

In certain embodiments, the compound of Formula (V) can be:

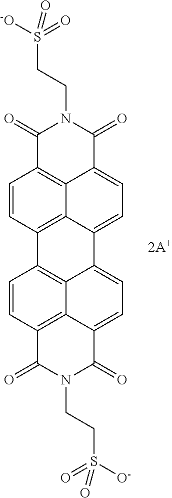

The redox flow batteries in accordance with many embodiments can include a catholyte solution in the cathode chamber. In some embodiments, the catholyte solution comprises a water soluble redox-active organic molecule. In certain embodiments, the redox-active component of the catholyte can include (but are not limited to) TEMPO, ferrocyanide, iodine, or other catholyte materials.

In some embodiments, the redox-active component of the catholyte solution is a water-soluble ferrocene-based compound. In certain embodiments, the ferrocene core can be solubilized through attachment of an ionic scaffold. In several embodiments, the scaffold may contain ammonium ions. In a number of embodiments, the scaffold may contain carboxylate ions. In some embodiments, the scaffold may contain sulfonate ions. Any common ionic group may be used to solubilize the ferrocene core including (but not limited to) carboxylates, phosphonates, sulfonates, imidizoliums, pyridiniums, and thiazoliums.

In some embodiments, the ferrocene molecules can be modified with at least two cationic groups; or at least three cationic groups; or at least four cationic groups; or at least five cationic groups; or with at least two anionic groups; or at least three anionic groups; or at least four anionic groups; or at least five anionic groups. The cationic and/or anionic groups can be the same or can be different. Examples of the cationic groups include (but are not limited to) quaternary ammonium groups, imidazolium groups, pyridinium groups, imidazolium groups, and thiazolium groups. Examples of the anionic groups include (but are not limited to) carboxylates, phosphonates, and sulfonate groups. Many embodiments provide that ferrocene molecules with less than two cationic (anionic) groups have a higher crossover rate than the ferrocene molecules with at least two cationic (anionic) groups.

Many embodiments provide that the ferrocene molecules are water soluble. In certain embodiments, the catholyte solutions can include ferrocene compounds dissolved in water without additional solvents. The ferrocene compounds can be dissolved in (but not limited to) water, tap water or deionized water. In some embodiments, the catholyte solutions can include supporting electrolytes including (but not limited to) NaCl, KCl, NH₄Cl, Na₂SO₄, MgCl₂, or a mixture thereof. In certain embodiments, the catholyte solutions may include a co-solvent to increase the solubility of the ferrocene compounds in the aqueous solution. Examples of co-solvents include (but are not limited to) methanol, propylene carbonate and ethylene glycol.

In many embodiments, the catholyte solutions can be prepared in an acidic, neutral or basic media. In several embodiments, the catholyte solutions can be prepared at a neutral pH (pH at about 7); or pH from about 6 to about 8; or pH from about 6.5 to about 7.5. Some embodiments prepare the catholyte solutions in a basic media with pH of the catholyte solutions ranging from about 7.5 to about 10. In a number of embodiments, the catholyte solutions can be prepared in an acidic media with pH of the catholyte solutions ranging from about 4 to about 6.5; or from about 5 to about 6.5. In some embodiments, the pH of the catholyte solutions can be neutral or close to neutral (pH ranging from about 5.5 to about 8.5). In several embodiments, the catholyte solutions can be prepared using tap water.

In various embodiments, the ferrocene-based molecule has one of the following structures:

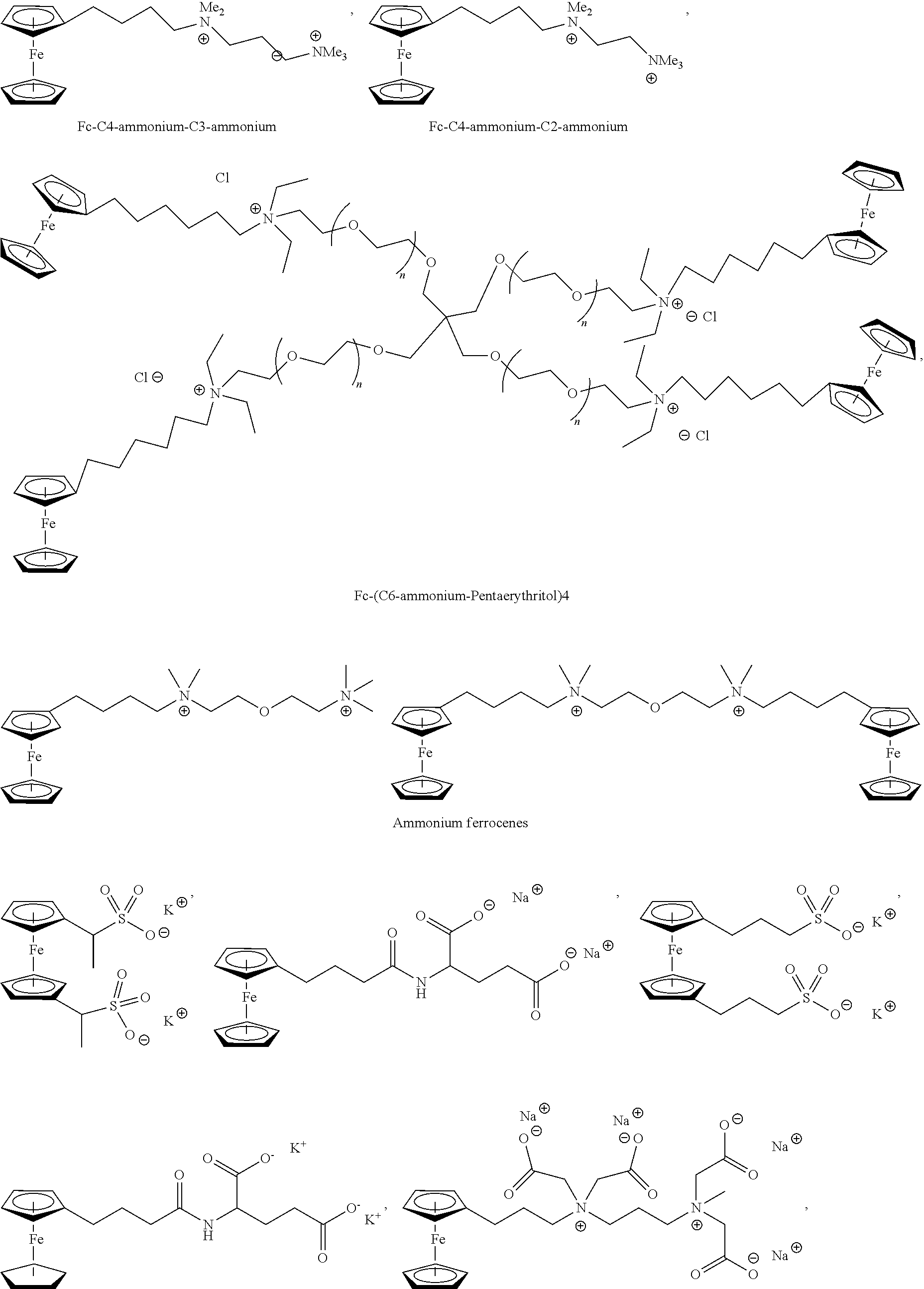

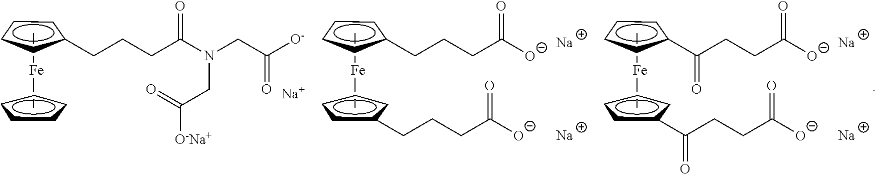

In some embodiments, the ferrocene compounds have the structure of Formula (VI):

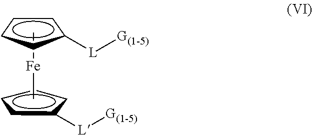

wherein:
L is —(C₁-C₁₀)-alkyl, —(C₁-C₆)-alkenyl, —(C1-C6)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl-(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, —(C₁-C₁₀)-alkyl-aryl, each optionally substituted by one, two, or more G, —OH, —OCH3, -halo;
L′is —H, —(C₁-C₁₀)-alkyl, —(C₁-C₆)-alkenyl, —(C1-C6)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl-(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, —(C₁-C₁₀)-alkyl-aryl, each optionally substituted by one, two, or more G, —OH, —OCH3, -halo;
each G may be independently selected from

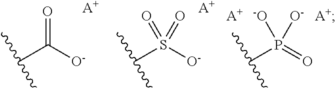

the number of G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl, and may be optionally substituted by one or more G.

In certain embodiments, the L-Gₙ group may have one or more chiral centers. If that is the case, the resulting compound of Formula (VI) may have several stereoisomers. In some embodiments, the compound may be a single stereoisomer. In other embodiments, the compound may be a mixture of two or more stereoisomers in any ratio. The mixture may comprise every stereoisomer of a compound, or it may exclude one or more. If no chirality is indicated at the stereocenter, then the compound may be comprised of any mixture of stereoisomers.

In certain embodiments, the compound of Formula (VI) can be:

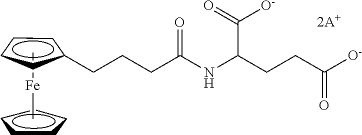

In certain embodiments, the compound of Formula (VI) can be:

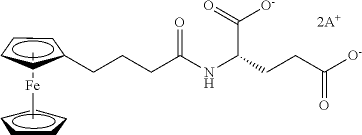

In certain embodiments, the compound of Formula (VI) can be:

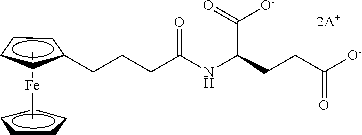

In certain embodiments, the compound of Formula (VI) can be any mixture of the following stereoisomers:

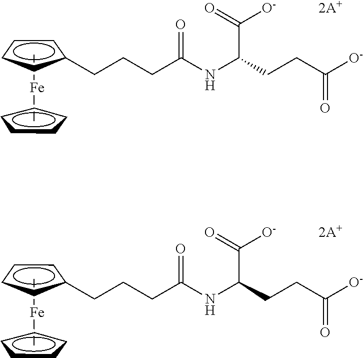

In certain embodiments, the compound of Formula (VI) can be:

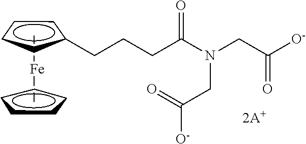

In certain embodiments, the anolyte and/or catholyte solutions may contain a supporting electrolyte. The supporting electrolyte may not be necessary in the anolyte and/or catholyte solutions in several embodiments. Any supporting electrolyte can be used including (but not limited to) inorganic salts and organic salts. Representative inorganic salts include (but are not limited to) NaCl, KCl, LiCl, NaBr, KBr, LiBr, NaI, KI, LiI, MgCl₂, CaCl₂, MgBr₂, CaBr₂, MgI₂, and CaI₂, NH₄Cl, NH₄Br, and NH₄I. Representative organic salts include (but are not limited to) alkylammonium chloride, alkylammonium bromide, alkylammonium iodide, sodium tosylate, and sodium besylate. In some embodiments, the solution may also contain co-solvents including (but not limited to) sulfolane or propylene carbonate.

In many embodiments, the redox flow batteries comprise the aqueous anolyte and catholyte solutions. The anolyte and catholyte solutions can be pumped through tubing into the half cells where they undergo electrochemical reactions. The anolyte and catholyte solutions can be cycled through the half cells in repeated charge and discharge cycles. The materials used to fabricate the battery components including (but not limited to) electrodes, gaskets, flow plates, bipolar plates, membrane frames, and membranes (also referred as separators), need to be compatible with the anolyte and catholyte solutions to ensure long lifetime of the battery. The membrane in the battery separates the anode and cathode sides. They need to prevent the crossover of active species for each half-cell and must also exhibit high ionic conductivity, low area electrical resistance, and good chemical stability. Membranes in the batteries can be ion-exchange membranes or size-exclusion membranes. In many embodiments, the membranes of the redox flow batteries can be made from non-fluorinated polymers. In some embodiments, the membranes can be made from hydrocarbon polymers including (but not limited to) polyethylene, polypropylene, polystyrene, polyether ether ketone. These hydrocarbon membranes include non-fluorinated charge conducting groups including (but not limited to) ammoniated polystyrenes, ammoniated polyether ether ketones, sulfonated polyether ether ketones and sulfonated polystyrenes. Certain embodiments use Selemion™ AMVN as anion exchange membranes in the redox flow batteries. Certain embodiments use Selemion™ CMVN as cation exchange membranes in the redox flow batteries. Certain embodiments use Fumasep™ FAA-3-20 as anion exchange membranes in the redox flow batteries. Certain embodiments use Fumasep™ FAA-3-50 as anion exchange membranes in the redox flow batteries. Certain embodiments use Fumasep™ FAS-30 as anion exchange membranes in the redox flow batteries. Certain embodiments use Fumasep™ FAM-PP as anion exchange membranes in the redox flow batteries. Certain embodiments use Fumasep™ FAPQ-375-PP as anion exchange membranes in the redox flow batteries. Certain embodiments use Fumasep™ FKS-PK-75 as cation exchange membranes in the redox flow batteries. Certain embodiments use Fumasep™ FKS-50 as cation exchange membranes in the redox flow batteries. Certain embodiments use Fumasep™ E620K as cation exchange membranes in the redox flow batteries.

The anolytes comprising perylene diimide in accordance with several embodiments provide stability for a long lifetime redox flow battery. The catholytes comprising ferrocene in accordance with some embodiments provide stability for a long lifetime redox flow battery. As used herein, the term “long lifetime” refers to a battery having stable capacity retention over repeated charge cycles or temporal time. In many embodiments, the redox flow batteries can have a lifetime of at least 5 years; or a lifetime of at least 10 years; or a lifetime of at least 20 years; or a lifetime of at least 50 years; or a lifetime of between 5 years and 50 years; or a lifetime of between 10 years and 50 years; or a lifetime of between 20 years and 50 years.

Coulombic efficiency is a direct measure of molecular stability in an organic flow battery. Coulombic efficiency is the number of electrons discharged out of the battery, compared to the number charged in during a cycle. For example, if the battery discharges 99 electrons from 100 electrons charged into the device in a given cycle, it has a coulombic efficiency of 99%. This can be a direct measure of molecular stability in an organic flow battery. Electrons can be lost in a variety of ways aside from molecular decomposition, such as leakage of solution out of the cell or crossover of active species across the membrane. However, molecular decomposition directly leads to observed coulombic efficiency loss. Although not all coulombic efficiency loss is due to molecular decomposition, molecular decomposition does lead to coulombic efficiency loss. It is possible for the molecules to be more stable than coulombic efficiency is showing, if leakage is the reason for a loss in coulombic efficiency. On the other hand, the molecule may not be less stable than coulombic efficiency shows. Any molecular decomposition will result in coulombic efficiency decrease. An example of such decomposition can be when the organic radical on the charged molecule is quenched due to a destructive chemical event-such as but not limited to dimerization and the formation of a permanent bond using two radicals, or solvent attack. A coulombic efficiency that shows a 500-year lifetime may have a molecular stability of 750-years, but may not have molecular stability less than the 500-year the coulombic efficiency shows.

In many embodiments, the redox flow batteries comprising stable and water-soluble perylene diimide anolytes as well as stable and water-soluble ferrocenes, exhibit high coulombic efficiencies at neutral pH (pH at about 7) or PH levels close to neutral (pH from about 6 to about 8; or pH from about 5.5 to about 8.5). In several embodiments, the coulombic efficiency of the redox flow batteries can be at least 98% after at least about 200 charge/discharge cycles; or after at least 380 charge/discharge cycles. In some embodiments, the coulombic efficiency can be at least 98.5% after at least about 200 charge/discharge cycles; or after at least 380 charge/discharge cycles. In certain embodiments, coulombic efficiency is at least 99% after at least about 200 charge/discharge cycles; or after at least 380 charge/discharge cycles. In several embodiments, the coulombic efficiency is at least 99.5% after at least about 200 charge/discharge cycles; or after at least 380 charge/discharge cycles. In some embodiments, coulombic efficiency is at least 99.6% after at least about 200 charge/discharge cycles; or after at least 380 charge/discharge cycles. In certain embodiments, coulombic efficiency is at least 99.7% after at least about 200 charge/discharge cycles; or after at least 380 charge/discharge cycles. In many embodiments, coulombic efficiency is at least 99.9% after at least about 200 charge/discharge cycles; or after at least 380 charge/discharge cycles. In some embodiments, coulombic efficiency is about 100% after at least about 200 charge/discharge cycles; or after at least 380 charge/discharge cycles. In several embodiments, the coulombic efficiency is between about 98.5% and about 99.5% after at least about 200 charge/discharge cycles; or after at least 380 charge/discharge cycles. In certain embodiments, the coulombic efficiency is between about 99% and about 99.5% after at least about 200 charge/discharge cycles; or after at least 380 charge/discharge cycles. In several embodiments, the coulombic efficiency is between about 99.5% and about 99.9% after at least about 200 charge/discharge cycles; or after at least 380 charge/discharge cycles.

The high coulombic efficiencies of the redox flow batteries in accordance with many embodiments enable long lifetimes of the charge storage species in the batteries. In several embodiments, the half-life of the species in the batteries (i.e., time needed for the battery to lose half of its charge storing ability due to molecular degradation) can be greater than about 10 years. In some embodiments, the half-life of the charge storage materials for redox flow batteries can be greater than about 20 years. In certain embodiments, the half-life of the charge storage materials for redox flow batteries can be greater than about 50 years. In some embodiments, the half-life of the charge storage materials for redox flow batteries can be greater than about 70 years. In several embodiments, the half-life of the charge storage materials for redox flow batteries can be greater than about 100 years. In various embodiments, the half-life of the charge storage materials for redox flow batteries can be greater than about 200 years. In many embodiments, the half-life of the charge storage materials for redox flow batteries can be greater than about 500 years. In some embodiments, the half-life of the charge storage materials for redox flow batteries can be greater than about 1,000 years. In several embodiments, the half-life of the charge storage materials for redox flow batteries can be greater than about 2,000 years. In certain embodiments, the half-life of the charge storage materials for redox flow batteries can be greater than about 3,000 years. In some embodiments, the half-life storage materials for redox flow batteries of the disclosure can be greater than about 5,000 years. In a number of embodiments, the half-life of the charge storage materials for redox flow batteries is between about 50 years and about 100 years. In some embodiments, the half-life of the charge storage materials for redox flow batteries is between about 100 years and about 500 years. In various embodiments, the half-life of the charge storage materials for redox flow batteries is between about 500 years and about 1,000 years. In some embodiments, the half-life of the charge storage materials for redox flow batteries is between about 1,000 years and about 2,000 years. In several embodiments, the half-life of the charge storage materials for redox flow batteries is between about 2,000 years and about 3,000 years. In certain embodiments, the half-life of the charge storage materials for redox flow batteries is between about 2,000 years and about 5,000 years.

The performance of a redox flow battery can be measured by its capacity retention. If a redox flow battery loses minimal charge storing capacity during multiple charge/discharge cycles, it can ensure sufficient lifetime for the battery. The redox flow batteries in accordance with many embodiments lose negligible charge storage capacity over multiple charge/discharge cycles. In some embodiments, the redox flow batteries lose less than about 2% charge storing capacity after about 300 full charge/discharge cycles; or after about 380 full charge/discharge cycles. In several embodiments, the redox flow batteries lose less than about 1% charge storing capacity after about 300 full charge/discharge cycles; or after about 380 full charge/discharge cycles. In certain embodiments, the redox flow batteries lose less than about 0.5% charge storing capacity after about 300 full charge/discharge cycles; or after about 380 full charge/discharge cycles. In various embodiments, the redox flow batteries lose less than about 0.25% charge storing capacity after about 300 full charge/discharge cycles; or after about 380 full charge/discharge cycles. In a number of embodiments, the redox flow batteries lose less than about 0.1% charge storing capacity after about 300 full charge/discharge cycles; or after about 380 full charge/discharge cycles. In some embodiments, the redox flow batteries lose less than about 0.05% charge storing capacity after about 300 full charge/discharge cycles; or after about 380 full charge/discharge cycles. In several embodiments, the redox flow batteries lose less than about 0.03% charge storing capacity after about 300 full charge/discharge cycles; or after about 380 full charge/discharge cycles. In some embodiments, the redox flow batteries lose less than about 0.01% charge storing capacity after about 300 full charge/discharge cycles; or after about 380 full charge/discharge cycles. In certain embodiments, the redox flow batteries lose between about 0.05% and about 0.1% charge storing capacity after about 300 full charge/discharge cycles; or after about 380 full charge/discharge cycles. In several embodiments, the redox flow batteries lose between about 0.03% and about 0.1% charge storing capacity after about 300 full charge/discharge cycles; or after about 380 full charge/discharge cycles. In some embodiments, the redox flow batteries lose between about 0.01% and about 0.05% charge storing capacity after about 300 full charge/discharge cycles; or after about 380 full charge/discharge cycles.

Many embodiments provide that the redox flow batteries lose minimal charge storing capacity during operation. In some embodiments, the redox flow batteries lose less than about 2% charge storing capacity per year. In several embodiments, the redox flow batteries lose less than about 1% charge storing capacity per year. In certain embodiments, the redox flow batteries lose less than about 0.5% charge storing capacity per year. In certain embodiments, the redox flow batteries lose less than about 0.25% charge storing capacity per year. In some embodiments, the redox flow batteries lose less than about 0.1% charge storing capacity per year. In several embodiments, the redox flow batteries lose less than about 0.05% charge storing capacity per year. In certain embodiments, the redox flow batteries lose less than about 0.03% charge storing capacity per year. In some embodiments, the redox flow batteries lose less than about 0.01% charge storing capacity per year. In various embodiments, the redox flow batteries lose between about 0.05% and about 0.1% charge storing capacity per year. In several embodiments, the redox flow batteries lose between about 0.03% and about 1% charge storing capacity per year. In various embodiments, the redox flow batteries lose between about 0.01% and about 0.05% charge storing capacity per year.

### EXEMPLARY EMBODIMENTS

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

### Example 1. Crossover of Perylene Diimide Molecules

Appending cationic or anionic groups to perylene diimide core molecules can increase aqueous solubility. In addition, appending additional cationic or anionic groups to the core redox molecules substantially reduces crossover between the anode and cathode compartments. Many embodiments provide perylene diimide molecules that have one or both imide nitrogen on the perylene diimide core covalently bond to a substituent with at least two anionic groups, or at least two cationic groups, can minimize the crossover rate in redox flow batteries. In some embodiments, ammonium ions can be appended to the perylene diimide core molecules to reduce crossover rates across anionic exchange membranes. Several embodiments provide the crossover tests with PDI-C3-NMe2-TEG molecules with the formula shown below:

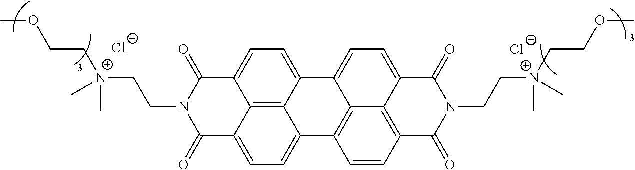

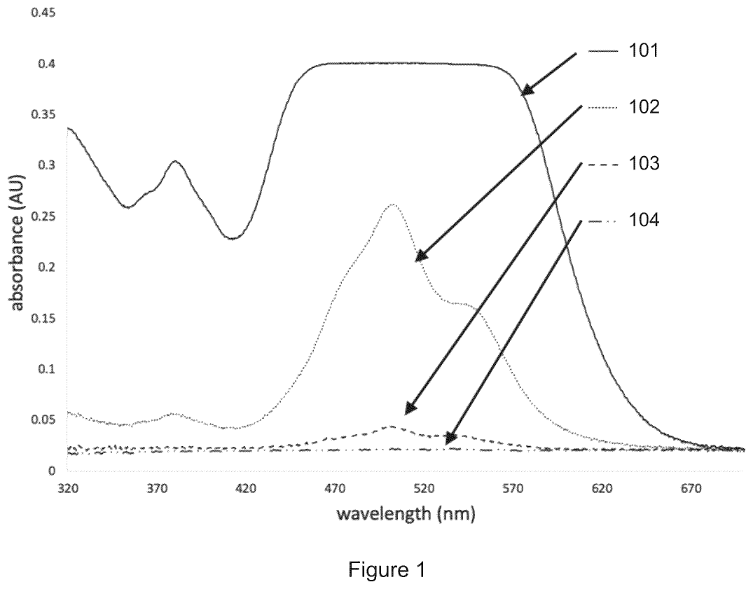

UV-Vis tests can be used to test the crossover rate of PDI-C3-NMe2-TEG molecules. FIG. 1 illustrates the detection limit of PDI-C3-NMe2-TEG using UV-Vis in accordance with an embodiment of the invention. FIG. 1 shows calibration curve of concentration dependent absorption of PDI via UV/Vis Spectroscopy. PDI-C3-NMe2-TEG with concentrations (dissolved in 1 M NaCl solutions) from about 1 μM, about 0.1 μM, about 0.01 μM, and about 0.001 μM are tested with UV-Vis. 1 μM PDI-C3-NMe2-TEG is equivalent of about 0.04% crossover, shown in 101. 0.1 μM PDI-C3-NMe2-TEG is equivalent of about 0.004% crossover, shown in 102. 0.01 μM PDI-C3-NMe2-TEG is equivalent of about 0.0004% crossover, shown in 103. 0.001 μM PDI-C3-NMe2-TEG is equivalent of about 0.00004% crossover, shown in 104. As shown in FIG. 1, observable absorbance of PDI-C3-NMe2-TEG molecules can be seen with concentrations of about 1 μM 101, about 0.1 μM 102, and about 0.01 μM 103. 0.001 μM PDI-C3-NMe2-TEG 104 does not show an absorbance peak in UV-Vis. UV-Vis test shows about 0.01 μM limit of detection of PDI-C3-NMe2-TEG.

For the crossover rate tests, about 2.5 mM solution of PDI-C3-NMe2-TEG can be prepared in about 1 M NaCl solution. About 100 mL of this solution can be added to one side of a redox flow battery chamber with a membrane (Selemion™ AMVN). The membrane has a cross section area of about 5 cm². The opposing, “blank”, side of the battery can be filled with 100 mL of about 1M NaCl solution and the solutions can be circulated at approximately 25 mL/min for about 90 days. After 90 days, UV-Vis data from the blank side can be collected and analyzed.

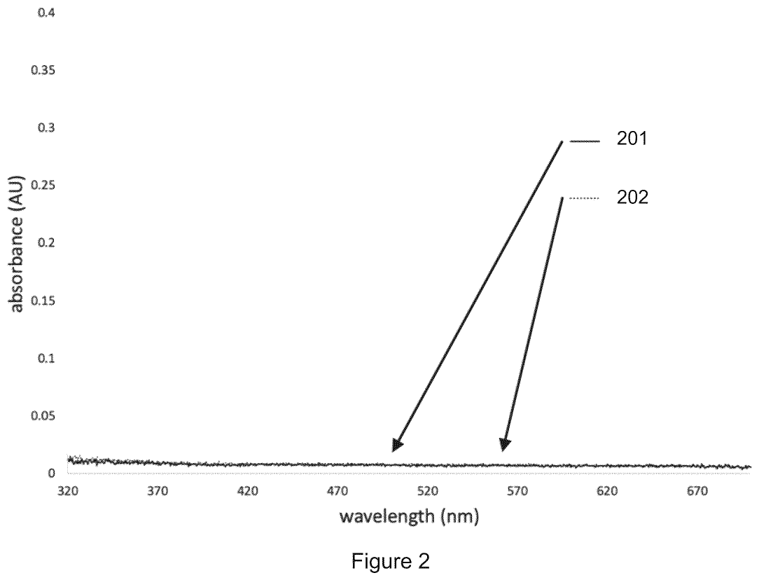

FIG. 2 illustrates the time dependent crossover tests for PDI-C3-NMe2-TEG molecules in accordance with an embodiment of the invention. FIG. 2 shows the UV-vis measurement of the “blank” side of the redox flow battery after cycling for 90 days 202, and the measurement of 1 M NaCl solution 201. As shown in FIG. 2, no absorbance peaks can be detected with UV-Vis for the PDI molecule. FIG. 2 shows the absence of PDI indicating a crossover rate of less than 0.0004% in 90 days (4.4*10⁻⁶% per day).

### Example 2. Crossover of Ferrocene Molecules

Appending cationic or anionic groups to the ferrocene core molecules can increase aqueous solubility, and also reduce crossover between the anode and cathode compartments. Many embodiments provide ferrocene molecules that have at least two anionic groups, or at least two cationic groups, can minimize the crossover rate in redox flow batteries. In some embodiments, ammonium ions can be appended to the ferrocene core molecules to reduce crossover rates across anionic exchange membranes. Several embodiments provide the crossover tests with Fc-N2-5Me molecules with the formula shown below:

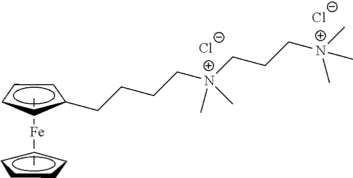

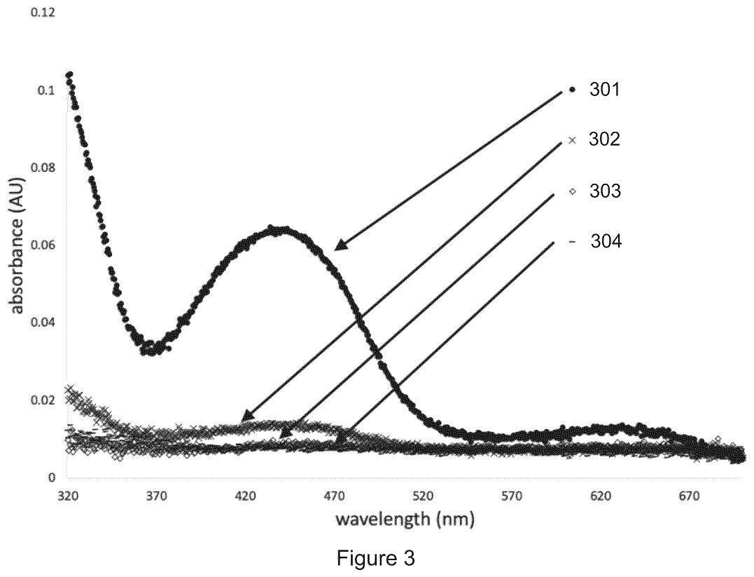

UV-Vis tests can be used to test the crossover rate of Fc-N2-5Me molecules. FIG. 3 illustrates the detection limit of Fc-N2-5Me using UV-Vis in accordance with an embodiment of the invention. Fc-N2-5Me with concentrations (dissolved in 1 M NaCl solutions) from about 1 mM 301, about 0.1 mM 302, and about 0.01 mM 303, are tested with UV-Vis. 1 M NaCl in water 304 can be used as a reference. 1 mM Fc-N2-5Me 301 is equivalent of about 0.2% crossover. 0.1 mM Fc-N2-5Me 302 is equivalent of about 0.02% crossover. 0.01 mM Fc-N2-5Me 303 is equivalent of about 0.002% crossover. As shown in FIG. 3, observable absorbance of Fc-N2-5Me molecules can be seen with concentrations of about 1 mM 301 and about 0.1 mM 302. 0.01 mM Fc-N2-5Me 303 does not show an absorbance peak in UV-Vis. UV-Vis test has about 0.1 mM limit of detection of Fc-N2-5Me.

For the crossover rate tests, about 50 mM solution of Fc-N2-5Me can be prepared in about 1 M NaCl solution. About 100 mL of this solution can be added to one side of a redox flow battery chamber with a membrane (Selemion™ AMVN). The membrane has a cross section area of about 5 cm². The opposing, “blank”, side of the battery can be filled with 100 mL of about 1 M NaCl solution and the solutions can be circulated at approximately 25 mL/min for about 90 days. After 90 days, UV-Vis data from the blank side can be collected and analyzed.

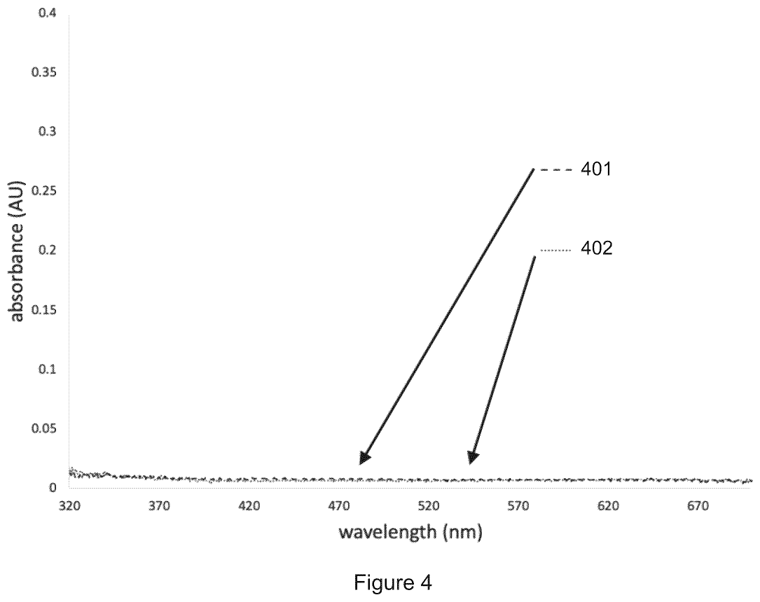

FIG. 4 illustrates the flow crossover tests for Fc-N2-5Me molecules in accordance with an embodiment of the invention. FIG. 4 shows the UV-vis measurement of the “blank” side of the redox flow battery after cycling for 90 days 402, and the measurement of 1 M NaCl solution 401. As shown in FIG. 4, no absorbance peaks can be detected with UV-Vis for the ferrocene molecule 402. FIG. 4 shows the absence of ferrocene indicating a crossover rate of less than 0.02% in 90 days (2.2*10⁻⁴% per day)

For the crossover rate tests, about 0.68 M ferrocene-monosodium glutamate (Fc-MSG) can be prepared in about 0.09 M NaCl solution. About 8 mL of this solution can be added to one side of a H-Cell battery chamber with a membrane (Selemion™ CMVN). The membrane has a cross section area of about 3 cm². The opposing, “blank”, side of the H-cell can be filled with about 8 mL of about 1.45 M KCl solution and the solutions can be stirred for 18 days. After 18 days, UV-Vis data from the blank side can be collected and analyzed.

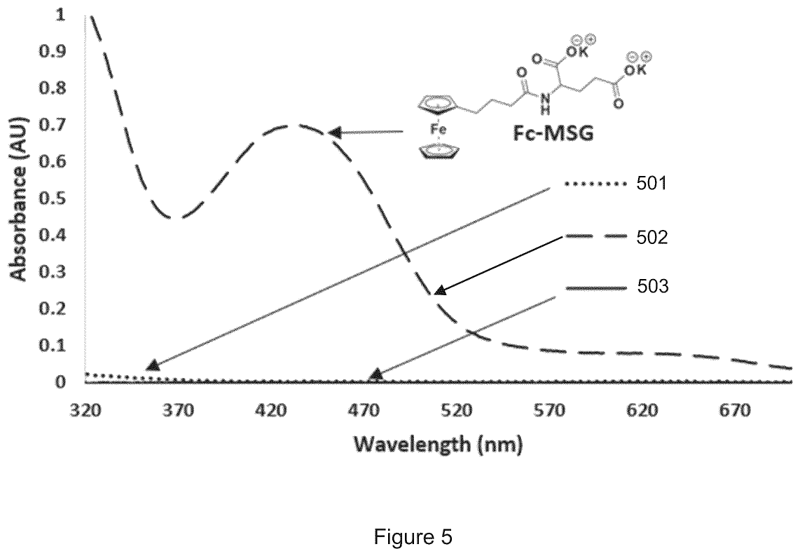

FIG. 5 illustrates the flow crossover tests for Fc-MSG molecules in accordance with an embodiment of the invention. FIG. 5 shows the UV-Vis measurement of the 1.65 M KCl side of the H-cell battery after stirring for 0 days 503 and after 18 days 501. The Fc-MSG side after stirring 18 days 502 is shown for reference. As shown in FIG. 5, no absorbance peaks can be detected for the 1.45 M KCl salt side with UV-Vis for the ferrocene molecule 501. FIG. 5 shows the absence of ferrocene indicating a crossover rate of less than 0.02% in 14 days (2.2*10⁻⁴% per day)

For the crossover rate tests, about 1.0 M ferrocene-butyric acid (or ferrocene-butanoic acid (Fc-BA) can be prepared in about 0.1 M NaCl solution. About 8 mL of this solution can be added to one side of a H-Cell battery chamber with a membrane (Selemion™ CMVN). The membrane has a cross section area of about 3 cm². The opposing, “blank”, side of the H-cell can be filled with 8 mL of about 1.1 M KCl solution and the solutions can be stirred for 18 days. After 18 days, UV-Vis data from the blank side can be collected and analyzed.

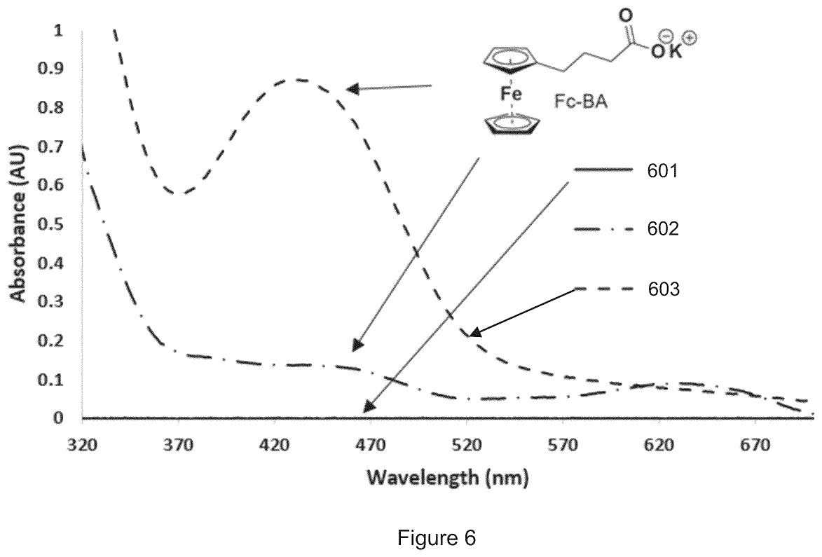

FIG. 6 illustrates the flow crossover tests for Fc-BA molecules in accordance with an embodiment of the invention. FIG. 6 shows the UV-Vis measurement of the 1.1 M KCl side of the H-cell battery after stirring for 0 days 601 and after 18 days 602. The Fc-BA side after stirring 18 days 603 is shown for reference. As shown in FIG. 6, absorbance peaks can be detected for the 1.1 M KCl salt side with UV-Vis for the Fc-BA molecule after 18 days 603. FIG. 6 shows the presence of ferrocene indicating a crossover rate of greater than 0.02% in 18 days (2.2*10⁻⁴% per day)

### Example 3. Crossover of the Redox Flow Battery

Many embodiments provide ferrocene molecules that have less than two anionic groups, or less than two cationic groups, can have higher crossover rate in redox flow batteries and cause battery capacity degradation. Several embodiments provide the crossover tests with Fc-Ac-SO3Na molecules with the formula shown below:

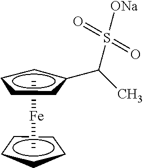

The functional groups on the ferrocene of Fc-Ac-SO3Na molecules comprise of a single anionic group. H-cell tests using the Fc-Ac-SO3Na molecules can be carried out to test the battery capacity. A glass H cell fitted with carbon felt electrodes and Selemion™ AMVN membrane can be filled with aqueous solutions with containing the equivalent of about 1.25 mAh of Fc-Ac-SO3Na as catholyte and about 1.25 mAh of monosodium glutamate-PDI (MSG-PDI) as anolyte both dissolved in about 1 M KCl at concentrations of approximately 0.006 M and 0.003M respectively. This cell can be charged and discharged for 107 cycles over 30 days.

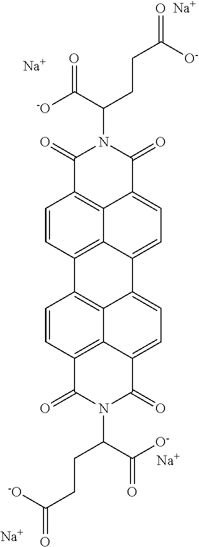

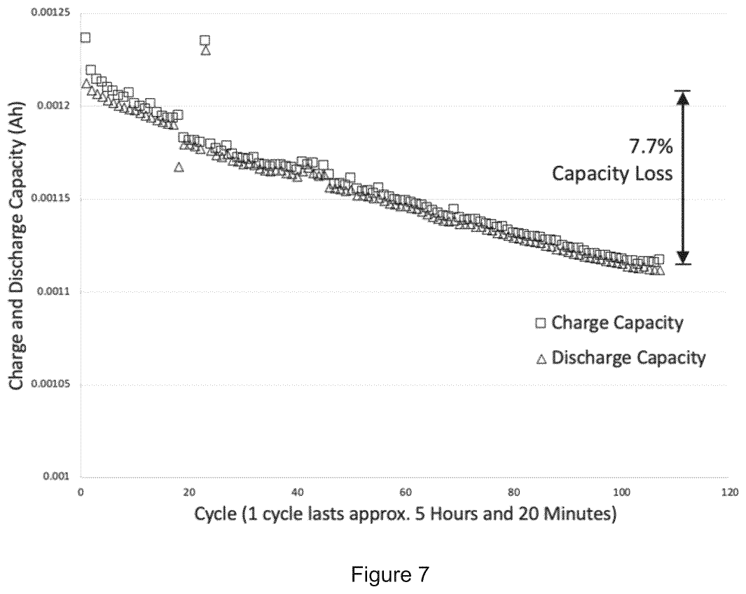

FIG. 7 illustrates the charge and discharge capacity of the H-cell in accordance with an embodiment of the invention. As shown in FIG. 7, the charge and discharge capacity of the cycling H-cell shows decay of the battery capacity caused by crossover of Fc-Ac-SO3Na. Total capacity loss from the first cycle to the 107^{th} cycle is measured at about 7.7%.

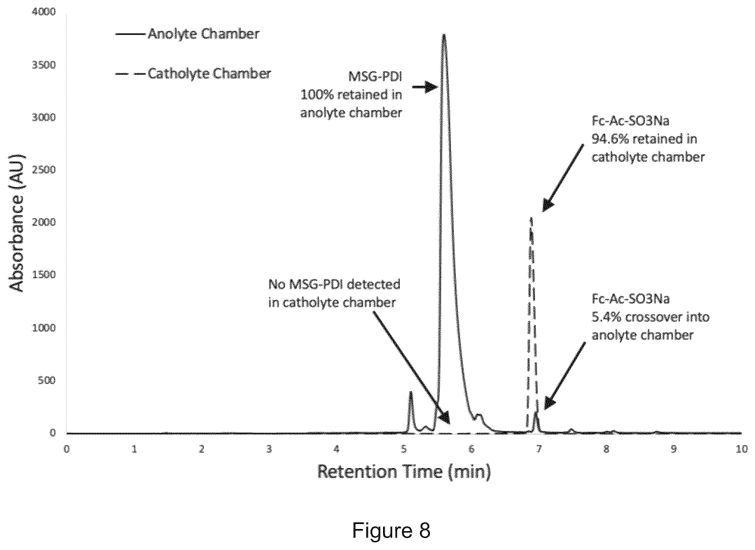

To analyze the cause of the battery decay, the composition of both catholyte and anolyte of the cell can be analyzed by HPLC. FIG. 8 illustrates HPLC spectrum of the catholyte and the anolyte after the H-cell cycling tests in accordance with an embodiment. HPLC data shows a separation spectrum measured via UV/Vis absorption of the catholyte solution (dashed line) and the anolyte solution (solid line), which separate spectra are then overlaid onto each other. The peak at about 6.9 minutes corresponds to Fc-Ac-SO3Na. The peak at about 5.58 minutes corresponds to MSG-PDI. As shown in FIG. 8, the catholyte solution (Fc-Ac-SO3Na) contains no anolyte (no crossover of MSG-PDI). The anolyte solution (MSG-PDI) contains about 5.4% of the total catholyte in the battery (Fc-Ac-SO3Na), demonstrating crossover of Fc-Ac-SO3Na and accounting for the majority of the capacity loss.

### Example 4. Coulombic Efficiency of the Redox Flow Battery

Many embodiments provide redox flow batteries with negligible crossover and coulombic efficiency of higher than about 99.9%. An H-cell can be used for the coulombic efficiency tests. The anolytes can include PDI-tetraammonium-Cl₄ in the anolyte half-cell and the catholyte can include ferrocene-diammonium-Cl₂ in the catholyte half-cell for the H-cell tests. The electrolyte can be dissolved in about 1 M sodium chloride for electrochemical stability testing. The moles of anolyte and catholyte molecules present can be controlled to achieve the desired capacity of 1 mAh. During the charge-discharge cycle, the PDI-tetraammonium-Cl₄ accepts and donates two electrons per molecule, whereas the ferrocene-diammonium-Cl₂ only accepts and donates one electron per molecule. Thus, the molar concentration of PDI-tetraammonium-Cl₄ is half of that of ferrocene-diammonium-Cl₂ in the H-Cell. Selemion™ anion exchange membrane (AMVN) can be used for the H-cells. The H-cell shows almost no crossover and exhibits an average coulombic efficiency of about 100% after testing of about 20 days.

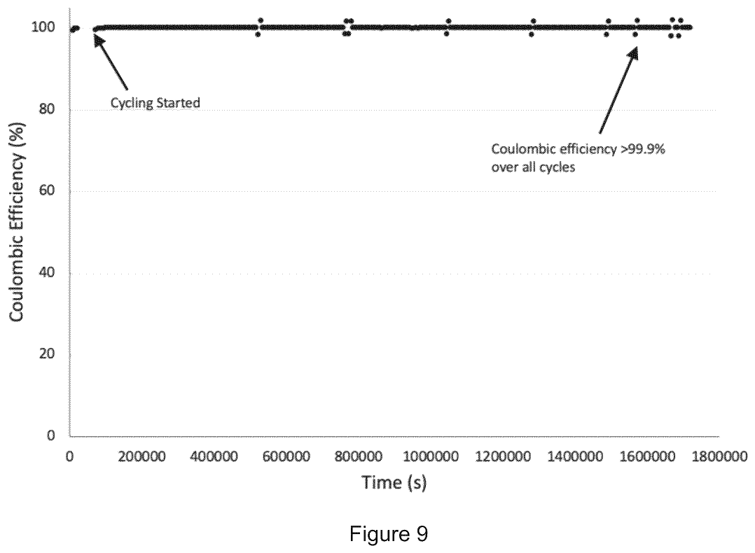

FIG. 9 illustrates the cycling data from a 10 mAh flow cell in accordance with an embodiment of the invention. The flow rate can be set to approximately 10 mL/min. The flow cell is cycled for about 20 days and about 380 cycles. This long-term cycling test in FIG. 9 shows higher than 99.9% coulombic efficiency. The average coulombic efficiency is about 100%.

### Example 5. Synthesis of N-butanoyl-4-ferrocenyl iminodiacetic acid

Several embodiments provide synthesis schemes of N-butanoyl-4-ferrocenyl iminodiacetic acid (molecular structure shown below). Ferrocene butyric acid (10 g, 0.037 mol) can be dissolved in DCM (50 mL), and a few drops of DMF were added. Oxalyl chloride (5.13 g, 3.47 mL, 0.40 mol) is added dropwise over 5 minutes and the resulting mixture stirred for 45 minutes. The solvent is removed by rotovap to give the product as a red oil. A solution of iminodiacetic acid (9.78 g, 0.074 mol) in 6 M NaOH (24 mL) is diluted with acetone (12 mL). The solution is diluted with water until the mixture becomes homogeneous (30 mL). The iminodiacetic acid solution and the neat acid chloride are simultaneously pushed through a static mixer, and the resulting reaction mixture is stirred for 20 minutes. The reaction mixture was diluted to 150 mL. The pH is adjusted to 4.9 with 2 M HCl and the solution is extracted with two portions of DCM. The organic layers are discarded. The aqueous layer is adjusted to pH 2.8 with 6 M HCl and under vigorous stirring a solid precipitated. The solid is collected by filtration, washed with water, 0.1 M HCl, and water twice more. The solid is dried to give the product as a gray-yellow solid (7.74 g, 0.02 mol, 54%). 1H NMR: (d-DMSO, 500 MHz) δ 1.72-1.65 (m, 2H), 2.29-2.24 (m, 4H), 3.96 (s, 1H), 4.03 (t, J=1.75 Hz, 2H), 4.075 (t, J=1.8 Hz, 1H), 4.11 (s, 5H), 4.1 (s, 5H), 4.14-4.12 (bs, 2H).

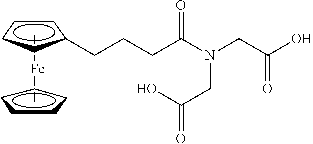

### Example 6. Synthesis of Water Soluble Perylene Diimide Redox-Active Compounds

Synthetic procedures for accessing perylene diimides are described below.

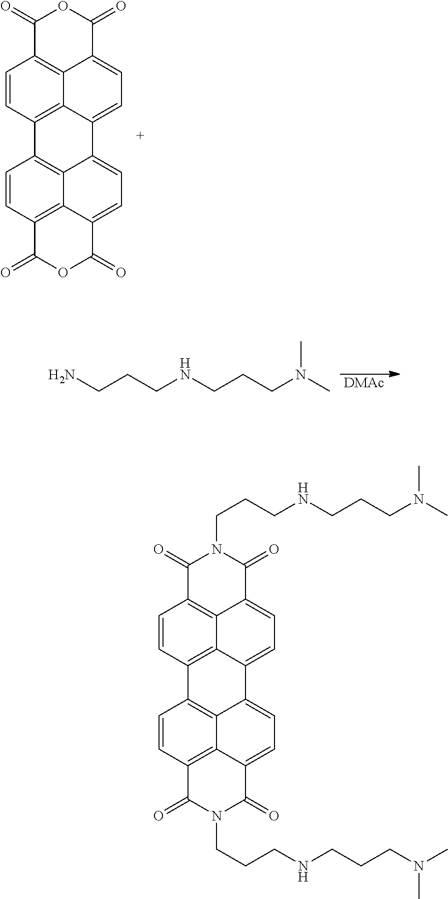

PTCDA (2.35 g, 6 mmol) was suspended in dimethylacetamide (20 mL) and stirred. N,N-Dimethyldiproylenetriamine (1.96 g, 2.22 mL, 12.3 mmol) was added and the solution was heated to 120° C. The solution at 120° C. for 12 hours, then cooled to ambient temperature. The reaction was poured into EtOAc (100 mL) and stirred vigorously. The precipitated solid was collected by filtration, washed with EtOAc, and dried under high vacuum to give the product as a deep purple/red solid (2.5 g, 3.7 mmol, 62%). 1H NMR: (CDCl3, 300 MHz) δ 1.67 (tt, J=7.1 Hz, 7.1 Hz, 4H), 1.97 (tt, J=6.8 Hz, 6.8 Hz, 4H), 2.21 (s, 12H), 2.32 (t, J=7.4 Hz, 4H), 2.71 (dt, J=18.2 Hz, 7 Hz, 8H), 4.23 (t, J=6.8 Hz, 4H), 8.13 (d, J=7.2 Hz, 4H), 8.35 (d, J=7.8 Hz, 4H).

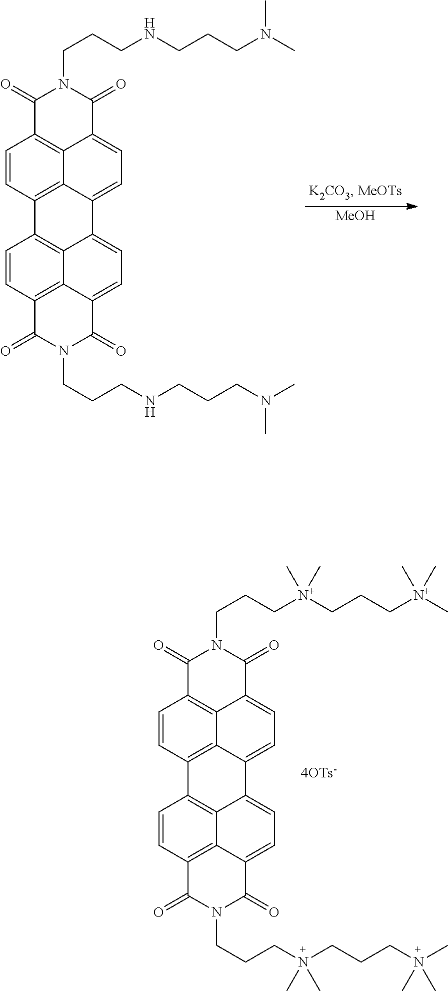

Tetraamine PDI (1.35 g, 2 mmol and potassium carbonate (0.829 g, 6 mmol) were suspended in methanol (20 mL). Methyl tosylate (4.47 g, 3.62 mL, 24 mmol) was added and the reaction was heated to 55° C. overnight. The reaction was cooled to ambient temperature, diluted with methanol (20 mL) and filtered to remove a white solid. The filtrate was concentrated to dryness by rotary evaporator and dissolved in a minimum amount of methanol. Acetone was added and a red solid precipitated from solution. The solid was isolated by filtration and dried at 55° C. under vacuum to give a dark red solid (2.05 g, 1.41 mmol, 71%). 1H NMR: (D2O, 300 MHz) δ 2.17 (s, 12H, OTs-), 2.43-2.25 (m, 8H), 3.14 (s, 18H), 3.22 (s, 12H), 3.38 (m, 4H), 3.47 (m, 4H), 3.62 (m, 4H), 4.12 (m, 4H), 7.29-7.10 (bs, 4H), 7.17 (d, J=8.2 Hz, 8H, OTs-), 7.51 (d, J=8.2 Hz, 8H, OTs-), 7.69 (bs, 4H).

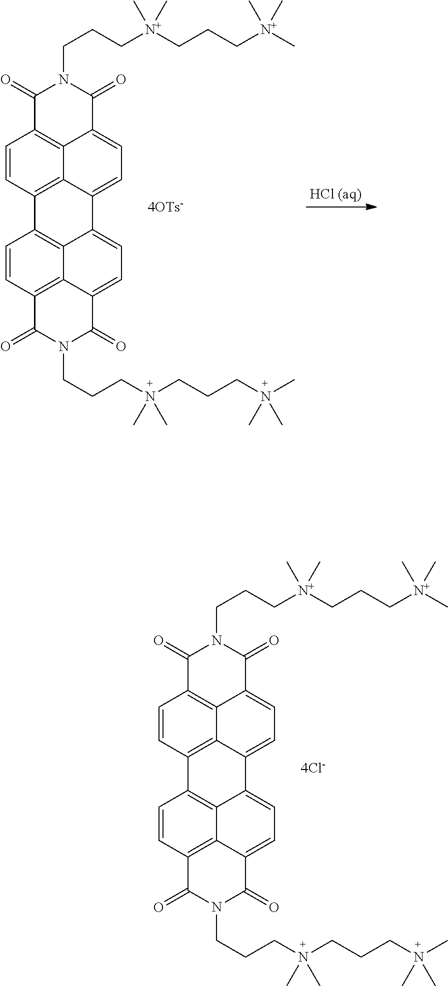

Tetraammonium tosylate PDI (2.90 g, 2 mmol) was dissolved in concentrated HCl (20 mL). The resulting mixture was heated to 85° C. for 24 hours. The reaction was cooled to ambient temperature and was diluted with isopropanol (60 mL) under vigorous stirring. The precipitated solution was collected by filtration, washed with isopropanol, and dried by at 70° C. under vacuum to give the product as a red/black solid (1.6 g, 1.77 mmol, 88%). 1H NMR: (D2O, 300 MHz) δ 2.71-2.12 (bm, 8H), 3.90-2.99 (bm, 42H), 4.21 (bs, 4H), 8.39-6.96 (bm, 8H).

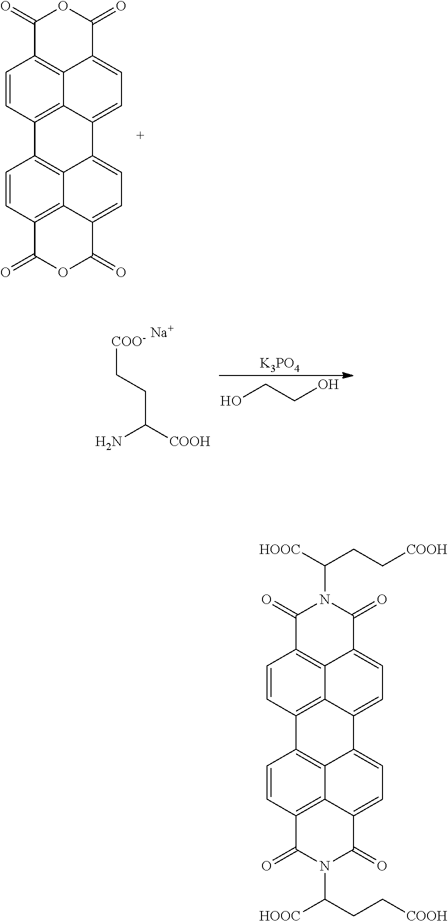

Glutamic Acid and PTCDA were suspended in DMSO. Under stirring, potassium phosphate tribasic was added and the solution was heated to 120° C. The reaction stirred for 18 hours and cooled to ambient temperature. 1 M HCl was added, and the precipitated solid was filtered to give the product as a purple/black solid (100% based on recovered starting material).

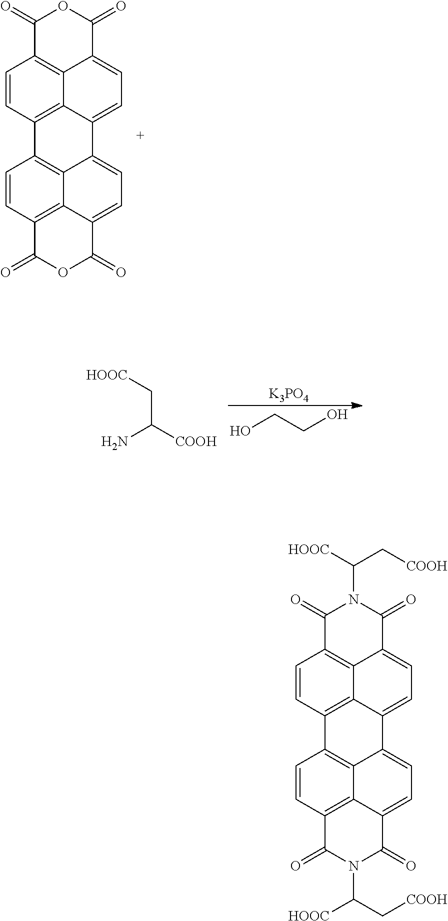

Aspartic acid (2.93 g, 22 mmol) and PTCDA (3.92 g, 10 mmol) were suspended in ethylene glycol. Potassium phosphate tribasic (9.9 g, 46 mmol) was added and the resulting solution was heated to 140° C. for 12 hours. The reaction cooled to ambient temperature and was poured into 1 M HCl (aq) (50 mL). The resulting precipitate was collected by filtration and washed with water and dried under vacuum at 55° C. to give the product as a purple solid (1.914 g, 3.07 mmol, 31%). 1H NMR: (D6-DMSO, 300 MHz) δ 2.85 (dd, J=16.6 Hz, 4.5 Hz, 2H), 3.42 (m, 2H), 6.08-6.01 (m, 2H), 8.43-7.67 (bm, 8H).

### Example 7. Synthesis of Water Soluble Ferrocene-Based Redox Active Compounds

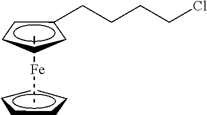

### 4-chlorobutylferrocene

Ferrocene (50 g, 269 mmol, 1.1 equivalents) was added to a 3-L 3-neck round-bottom flask charged with a stir bar and equipped with an addition funnel and a gas outlet leading to a bubbler filled with saturated aqueous NaHCO₃. The apparatus was purged with dry nitrogen gas. Dichloromethane (600 mL) was added and stirred to dissolve the ferrocene. The mixture was cooled to 0° C. in an ice water bath. In a separate round-bottom flask charged with a stir bar, aluminum trichloride (35.9 g, 269 mmol, 1.1 equivalents) was added and the flask was purged with dry nitrogen. Dichloromethane (600 mL) was added and stirred to suspend the aluminum trichloride. 4-Chlorobutyryl chloride (34.4 g, 245.5 mmol, 1.0 equivalents) was added dropwise to the aluminum trichloride suspension and stirred until dissolution of the aluminum trichloride stops. The acid chloride mixture was decanted from undissolved aluminum trichloride into the addition funnel of the reaction apparatus. This solution was added slowly to the ferrocene solution in the reaction vessel at 0° C. taking care not to allow the mixture to heat above 10° C. The mixture was then stirred for 3 hours while the bath was slowly warmed to ambient temperature. The vessel was once again cooled to 0° C. In a separate flask, sodium borohydride (18.5 g, 489 mmol, 2.0 equivalents) was combined with diglyme (70 mL) and dichloromethane (20 mL) under nitrogen atmosphere. This mixture was transferred to the addition funnel of the reaction vessel and added dropwise to the reaction mixture. The reaction was allowed to stir 18 hours at ambient temperature. Reaction was quenched at 0° C. by the addition of 1M aqueous ammonium chloride (100 mL) followed by water (100 mL) and a saturated aqueous solution of potassium sodium tartrate (400 mL). After the evolution of gas stopped, the organic layer was collected and the aqueous layer was extracted with dichloromethane (3 washes, 100 mL each), solvent was removed from the combined organic layers and the resulting liquid was dissolved in 500 mL of hexanes. The hexanes layer was washed with water (8 washes, 200 mL each) to remove diglyme, and dried by shaking with saturated aqueous sodium chloride solution. The organic layer was further dried over solid magnesium sulfate (100 g), filtered, and the solvent was removed to yield the desired product as an orange oil (60 g, 88%). ¹H NMR (300 MHz, Chloroform-d) δ (ppm) 4.11 (overlap, 9H), 3.58 (t, J=7.0 Hz, 2H), 2.40 (t, J=7.8 Hz, 2H), 1.84 (dt, J=6.8, 7.8, 2H), 1.71 (dt, J=6.8, 7.0, 2H).

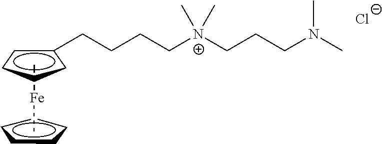

### N-[3-(dimethylamino)propyl]-N,N-dimethyl ferrocenebutaniminium chloride

4-Chlorobutylferrocene (75 g, 276.6 mmol, 1.0 equivalent), N,N,N′,N′-tetramethyl-1,3-propanediamine (105 g, 814 mmol, 3 equivalents) and acetonitrile (500 mL) were combined in a round-bottom flask and heated to 60° C. for 12 hours. The mixture was cooled and washed with hexanes (5 washes 150 mL per wash) the acetonitrile layer was reserved. The combined hexanes layers were evaporated to yield an orange liquid to which N,N,N′,N′-tetramethyl-1,3-propanediamine (50 g, 388 mmol, 1.43 equivalents) and acetonitrile (250 mL) were added in a round-bottom flask and the mix was heated to 60° C. for 12 hours. After cooling, the acetonitrile solution was washed with hexanes (5 washes 150 mL per wash) and the acetonitrile layer was combined with the reserved layer from the previous workup. The solvent was removed from the combined layers to yield an orange oil which was triturated with sonication with diethylether (200 mL). The ether was decanted off and volatiles were further removed under vacuum yielding the product as a very viscous orange oil (97 g, 88%) 1H NMR (300 MHz, Chloroform-d) δ (ppm) 4.08 (overlap, 9H), 3.53 (overlap, 4H), 3.40 (s, 6H), 2.44 (t, J=7.9, 2H), 2.36 (t, J=6.0, 2H), 2.19 (s, 6H), 1.83 (m, 2H), 1.70 (m, 2H), 1.58 (m, 2H).

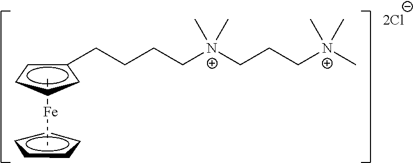

### N,N,N,N2,N2-pentamethyl-N2-ferrocenylbutyl-1,3-propanediaminium dichloride

N-[3-(dimethylamino)propyl]-N,N-dimethyl ferrocenebutaniminium chloride (97 g, 238 mmol, 1.0 equivalents) was dissolved in methanol (1000 mL). Iodomethane (101 g, 715.3 mmol, 3.0 equivalents) was added slowly via syringe and the mix was stirred at ambient temperature for 12 hours. Solvent and unreacted iodomethane were removed under reduced pressure and the residue was dissolved in water (200 mL) and stirred for one hour with Amberlite IRA-400 ion exchange resin beads (200 cm3) at which point the resin was filtered off and the solution was passed through a column of Amberlite IRA-400 ion exchange resin beads (500 cm3) with water as the eluent. Water was removed from the resulting solution to yield the product as a very viscous orange oil which crystalizes upon standing (94.4 g, 87%) 1H NMR (300 MHz, deuterium oxide) δ (ppm) 4.20 (overlap 9H), 3.34 (overlap, 6H), 3.16 (s, 9H), 3.09 (s, 6H), 2.42 (t, J=7.0, 2H), 2.27 (m, 2H), 1.76 (m, 2H), 1.55 (m, 2H).

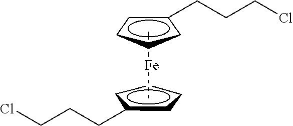

### 1,1′-bis(3-chloropropyl)ferrocene

Ferrocene (10.0 g, 53.4 mmol, 1.00 equivalent) was added to a 1-L 3-neck round-bottom flask charged with a stir bar and equipped with an addition funnel, a reflux condenser, and a gas outlet leading to a bubbler filled with saturated aqueous NaHCO3. The apparatus was purged with dry nitrogen gas. Dichloromethane (100 mL) was added and stirred to dissolve the ferrocene. The mixture was cooled to 0° C. in an ice water bath. In a separate round-bottom flask charged with a stir bar, aluminum trichloride (18.0 g, 134 mmol, 2.50 equivalents) was added and the flask was purged with dry nitrogen. Dichloromethane (100 mL) was added and stirred to suspend the aluminum trichloride. 3-Chloropropionyl chloride (17.0 g, 134 mmol, 2.50 equivalents) was added dropwise to the aluminum trichloride suspension and stirred until dissolution of the aluminum trichloride stops. The acid chloride mixture was decanted from undissolved aluminum trichloride into the addition funnel of the reaction apparatus. This solution was added slowly to the ferrocene solution in the reaction vessel at 0° C. taking care not to allow the mixture to heat above 10° C. The mixture was then heated to reflux for 16 hours. The vessel was once again cooled to 0° C. In a separate flask, sodium borohydride (8.00 g, 214 mmol, 4.00 equivalents) was combined with diglyme (40 mL) and dichloromethane (20 mL) under nitrogen atmosphere. This mixture was transferred to the addition funnel of the reaction vessel and added dropwise to the reaction mixture. The reaction was allowed to stir 18 hours at ambient temperature. Reaction was quenched at 0° C. by the addition of 1M aqueous ammonium chloride (100 mL) followed by water (100 mL) and a saturated aqueous solution of potassium sodium tartrate (100 mL). After the evolution of gas stopped, the organic layer was collected and the aqueous layer was extracted with dichloromethane (3 washes, 50 mL each), solvent was removed from the combined organic layers and the resulting liquidwwas dissolved in 200 mL of hexanes. The hexanes layer was washed with water (8 washes, 200 mL each) to remove diglyme, and dried by shaking with saturated aqueous sodium chloride solution. The organic layer was further dried over solid magnesium sulfate (50 g), filtered, and the solvent was removed to yield the desired product X as an orange oil (13 g, 72%). 1H NMR (300 MHz, Chloroform-d) δ (ppm) 4.10 (overlap, 8H), 3.58 (t, J=6.2 Hz, 4H), 2.50 (t, J=7.1 Hz, 4H), 1.98 (tt, J=6.2 Hz, 7.1 Hz, 4H).

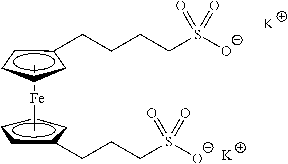

### Potassium 1,1′-bis(propyl-3-sulfonate)ferrocene

1,1′-bis(3-chloropropyl)ferrocene (1.5 g, 4.4 mmol, 1.0 equivalent), potassium sulfite (8.4 g, 53 mmol, 12 equivalents), and water (100 mL) were added to a 250-mL round bottom flask equipped with a condenser. The mixture was heated to reflux for 4 days during which time the immiscible ferrocene starting material slowly disappears as it is converted into water soluble products. The mixture was cooled and extracted with ethyl acetate (3 washes, 200 mL) to remove starting material. Water was removed from the aqueous layer and methanol (100 mL) was added. This mixture was filtered, and the methanol was removed by distillation. The resulting yellow solid was washed with copious isopropanol to remove acetate salts. After drying the product is obtained as a yellow powder (1.2 g, 54%). 1H NMR (300 MHz, deuterium oxide) δ (ppm) 4.06 (overlap, 8H), 2.84 (t, J=7.8 Hz, 4H), 2.40 (t, J=7.6 Hz, 4H), 1.98 (tt, J=7.8 Hz, 7.6 Hz, 4H).

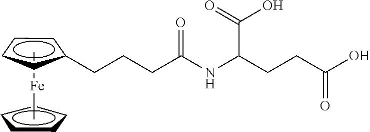

Ferrocene butane carboxylic acid (1.00 grams, 3.67 mmol) and N-hydroxysuccinimide (0.423 g, 3.67 mmol) were dissolved in DCM (18.5 mL) and the resulting mixture was stirred at ambient temperature. EDC (0.733 g, 4.04 mmol) was added, and the mixture was stirred at ambient temperature overnight. To a solution of glutamic acid (1.08 g, 7.3 mmol) in isopropanol (10 mL), triethylamine (2.02 g, 2.78 mL, 20 mmol) was added. After the dissolution of the glutamic acid, the crude solution of ferrocene N-hydroxysuccinimide activated ester was added to the glutamic acid mixture. The resulting mixture stirred 12 hours and ambient temperature, and was then heated to 90 degrees C. for 12 hours. The reaction mixture was quenched by the addition of 1 M NaOH, and washed with ethyl acetate. The aqueous layer was acidified with 1 M HCl and extracted with ethyl acetate. The ethyl acetate layer was washed with 0.01 M NaOH, and the aqueous wash was discarded. The organic layer was then extracted with two portions of 0.1 M NaOH. The aqueous extracts were combined, acidified with 1 M HCl, and extracted with EtOAc. The organic extract was washed with water and brine, dried over magnesium sulfate, filtered and concentrated to give the product as a yellow solid (0.200 g, 0.5 mmol, 14%). 1H NMR: (d-DMSO, 300 MHz) δ 1.83-1.63 (m, 4H), 2.03-1.90 (m, 1H), 2.14 (t, J=7.2 Hz, 2H), 2.32-2.23 (m, 4H), 4.05-4.01 (m, 1H), 4.08 (d, J=1.3 Hz, 2H), 4.1 (s, 5H), 4.21 (dt, J=8.5 Hz, 5.0 Hz, 1H), 8.08 (d, J=7.5 Hz, 1H).

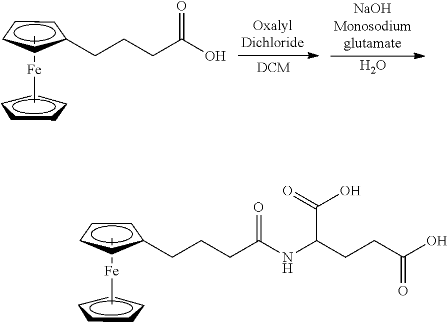

Synthesis of N-(4-ferrocenylbutanoyl)-L-glutamic acid. A 1-L round bottom flask was charged with 4-Ferrocenylbutanoic acid (68.0 g, 250 mmol, 1.0 equiv.). DCM (125 mL) and a stir bar. Under a positive pressure of N2 (g) and vigorous stirring, oxalyl chloride (23.6 mL, 275 mmol, 23.6 mL, 1.20 equiv.) was slowly added dropwise, being careful of gas evolution. The dark brown solution was stirred at 25° C. until gas evolution slowed (˜5 min). The reaction was then further heated to 40° C. and allowed to react for 1 hour. The solvent was removed by rotary evaporation.

A solution of sodium L-glutamate monohydrate (143 g, 763 mmol, 3.05 equiv.), sodium hydroxide (30.0 g, 750 mol, 3.0 equiv.), and water (68 mL) was prepared at 100° C. Once all solids dissolved, the previously prepared ferrocene acid chloride was added quickly to the stirring glutamate solution. During addition of acid chloride, the formation of a brown precipitate was observed. An extra ˜50 mL of water was added to aid in stirring of the reaction. Reaction was allowed to react at 100° C. for ˜5 min. Reaction was cooled to room temperature and water was added to completely dissolve all solids. NaCl (s) was added to completely saturate the aqueous solution. Resulting aqueous solution was titrated to a pH of 5.8 with HCl (6 M). Impurities were extracted with MeCN (4×200 mL). Resulting aqueous layer was further titrated to a pH of 3 with HCl (6 M). MeCN was used to extract the product from the aqueous layer until the resulting aqueous layer was a blue color (3×˜200 mL). ˜200 mL of silica and ˜200 mL of anhydrous sodium sulfate was added to the acetonitrile solution. The acetonitrile slurry was allowed to stir for 30 minutes at room temperature. The slurry was filtered through a fritted glass filter and the acetonitrile solution was collected. The dark red solution was concentrated by rotary evaporation. The resulting dark red oil was further concentrated in vacuo to yield a dark yellow-brown solid (53.8 g, 113 mmol, 45% yield, 84% purity).

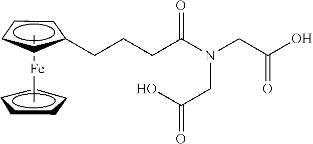

Synthesis of N-butanoyl-4-ferrocenyl iminodiacetic acid. Ferrocene butyric acid (10 g, 0.037 mol) was dissolved in DCM (50 mL), and a few drops of DMF were added. Oxalyl chloride (5.13 g, 3.47 mL, 0.40 mol) was added dropwise over 5 minutes and the resulting mixture stirred for 45 minutes. The solvent was removed by rotovap to give the product as a red oil. A solution of iminodiacetic acid (9.78 g, 0.074 mol) in 6 M NaOH (24 mL) was diluted with acetone (12 mL). The solution was diluted with water until the mixture became homogeneous (30 mL). The iminodiacetic acid solution and the neat acid chloride were simultaneously pushed through a static mixer, and the resulting reaction mixture was stirred for 20 minutes. The reaction mixture was diluted to 150 mL. The pH was adjusted to 4.9 with 2 M HCl and the solution was extracted with two portions of DCM. The organic layers were discarded. The aqueous layer was adjusted to pH 2.8 with 6 M HCl and under vigorous stirring a solid precipitated. The solid was collected by filtration, washed with water, 0.1 M HCl, and water twice more. The solid was dried to give the product as a gray-yellow solid (7.74 g, 0.02 mol, 54%). 1H NMR: (d-DMSO, 500 MHz) δ 1.72-1.65 (m, 2H), 2.29-2.24 (m, 4H), 3.96 (s, 1H), 4.03 (t, J=1.75 Hz, 2H), 4.075 (t, J=1.8 Hz, 1H), 4.11 (s, 5H), 4.1 (s, 5H), 4.14-4.12 (bs, 2H).

### Example 8. H-Cell Experiments Showing Stability of Anionic Water Soluble Perylene Diimide and Ferrocene Electrolyte Solutions

These experiments show that that the disclosed anionic electrolyte solutions are compatible in the charged and uncharged state. This static cell experimental setup allows for the accurate measurement of coulombic efficiency to analyze the electrochemical and physical compatibility of the charged electrolyte solution with a cell fabrication material. A high coulombic efficiency shows that the electrons placed into the organic charge storage electrolyte upon charging are returned upon discharge, meaning that the electrolyte did not electrochemically or physically react with anything, including the cell fabrication material, while in the charged state and thereby quench the charge.

An exemplary 1 mAh H-cell was fabricated using glutamic-PDI in the anolyte half-cell and bis-propyl-sulfonate ferrocene in the catholyte half-cell. The structures of these molecules are shown below. Cycling of glutamic-PDI and bis-propylsulfonate ferrocene is shown in FIG. 9. The cells were comprised of glass and the membrane was Selemion™ CMV. Each half cell was mixed with PTFE stir bars, while the electrodes were carbon felt. The coulombic efficiency of a set of cycles was measured. Cycles 10-40 showed >99.9% average coulombic efficiency, indicating that both the anolyte and catholyte electrolyte solutions are stable, since there is minimal electrochemical or physical degradation in the charged state. The capacity remained stable as well.

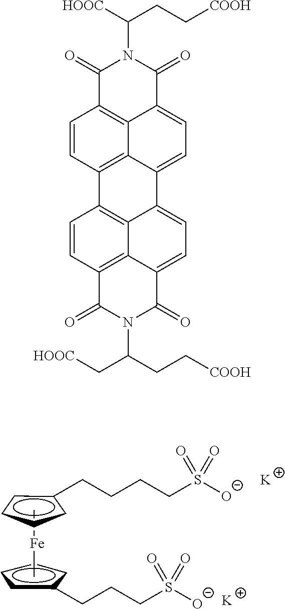

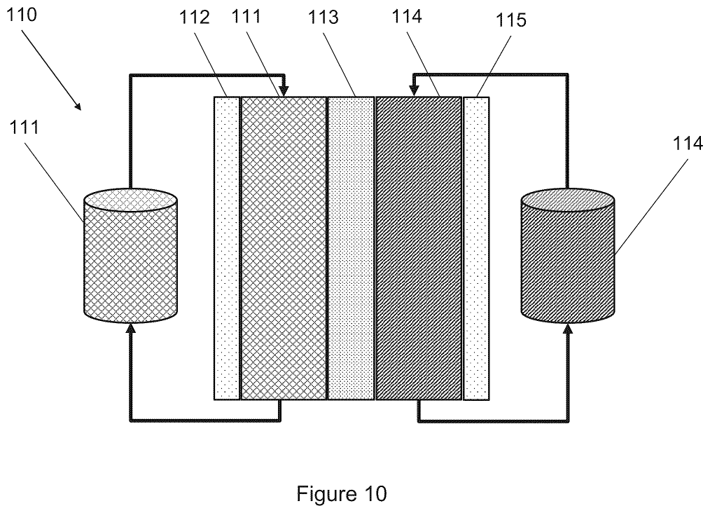

An exemplary 1 mAh H-cell was fabricated using glutamic-PDI in the anolyte half-cell and glutamic-amide ferrocene in the catholyte half-cell. The structures of these molecules are shown below. Cycling of glutamic-PDI and bis-propylsulfonate ferrocene is shown in FIG. 10. The cells were comprised of glass and the membrane was Selemion CMV. Each half cell was mixed with PTFE stir bars, while the electrodes were carbon felt. The coulombic efficiency of a set of cycles was measured. Cycles 10-40 showed 99.9% average coulombic efficiency, indicating that both the anolyte and catholyte electrolyte solutions are stable, since there is minimal electrochemical or physical degradation in the charged state. The capacity remained stable as well.

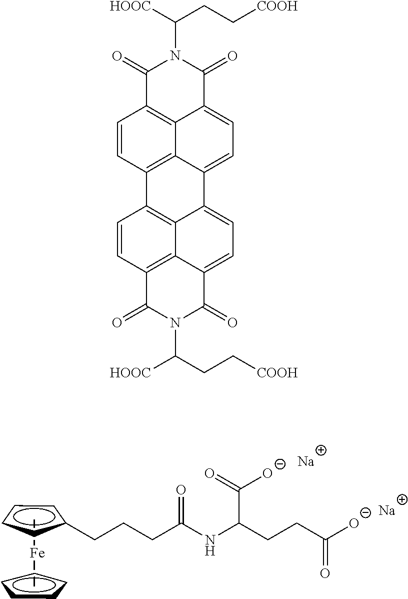

### Example 9. Redox Flow Batteries

FIG. 10 illustrates a redox flow battery with negligible crossover rate in accordance with an embodiment. The redox flow battery or a unit cell of a redox flow battery 110 can include two half-cells. One of the two half cells can be the cathode half-cell, and the other can be the anode half-cell. Catholyte (or cathode electrolyte) 111 can be pumped into the cathode half-cell, and anolyte (or anode electrolyte) 114 can be pumped into the anode half-cell. The anolyte and catholyte solutions can be cycled through the half cells in repeated charge and discharge cycles. The cathode half-cell and the anode half-cell can be connected with a membrane 113 for ion transport. The half-cells of the battery include various components including (but not limited to) electrodes, gaskets, flow plates, bipolar plates, and membranes. The materials used to fabricate the battery components including (but not limited to) electrodes, gaskets, flow plates, bipolar plates, membrane frames, and membranes (also referred as separators), need to be compatible with the anolyte and catholyte solutions to ensure long lifetime of the battery. In many embodiments, the redox flow batteries can include at least one unit cell; or at least 2 unit cells; or at least 5 unit cells; or at least 10 unit cells; or at least 15 unit cells; or at least 20 unit cells; or at least 25 unit cells; or at least 30 unit cells; or at least 50 unit cells; or at least 100 unit cells; or at least 150 unit cells.

The membrane 113 in the battery separates the anode 115 and cathode 112 sides. The membrane 113 need to prevent the crossover of active species for each half-cell and must also exhibit high ionic conductivity, low area electrical resistance, and good chemical stability. Membranes in the batteries can be ion-exchange membranes or size-exclusion membranes. In many embodiments, the membranes of the redox flow batteries can be made from non-fluorinated polymers. In some embodiments, the membranes can be made from hydrocarbon polymers including (but not limited to) polyethylene, polypropylene, polystyrene, polyether ether ketone. These hydrocarbon membranes include non-fluorinated charge conducting groups including (but not limited to) ammoniated polystyrenes, ammoniated polyether ether ketones, sulfonated polyether ether ketones and sulfonated polystyrenes. Certain embodiments use Selemion™ AMVN as anion exchange membranes in the redox flow batteries. Certain embodiments use Selemion™ CMVN as cation exchange membranes in the redox flow batteries. Certain embodiments use Fumasep™ FAA-3-20 as anion exchange membranes in the redox flow batteries. Certain embodiments use Fumasep™ FAA-3-50 as anion exchange membranes in the redox flow batteries. Certain embodiments use Fumasep™ FAS-30 as anion exchange membranes in the redox flow batteries. Certain embodiments use Fumasep™ FAM-PP as anion exchange membranes in the redox flow batteries. Certain embodiments use Fumasep™ FAPQ-375-PP as anion exchange membranes in the redox flow batteries. Certain embodiments use Fumasep™ FKS-PK-75 as cation exchange membranes in the redox flow batteries. Certain embodiments use Fumasep™ FKS-50 as cation exchange membranes in the redox flow batteries. Certain embodiments use Fumasep™ E620K as cation exchange membranes in the redox flow batteries.

In many embodiments, the anolytes 114 can include a compound with a perylene diimide moiety wherein the perylene diimide moiety comprises at least two ionic groups. The compound comprising the perylene diimide moiety can be water soluble. The ionic groups can be cationic groups or anionic groups. The compound comprising the perylene diimide moiety can have any of a formula as described in the disclosure. The multiple ionic groups in the perylene diimide compounds can reduce and/or eliminate crossover across the membrane.

In some embodiments, the catholytes 111 can include a compound with a ferrocene moiety wherein the ferrocene moiety comprises at least two ionic groups. The compound comprising the ferrocene moiety can be water soluble. The compound comprising the ferrocene moiety can have any of a formula as described in the disclosure. The multiple ionic groups in the ferrocene compounds can reduce and/or eliminate crossover across the membrane. The redox flow batteries can have the perylene diimide containing compounds in the anolyte and the ferrocene containing compounds in the catholyte.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A redox flow battery comprising:
a first half-cell containing a first aqueous solution comprising a first electrode and an anolyte comprising a compound with a perylene diimide moiety wherein the perylene diimide moiety comprises at least two ionic groups;
a second half-cell containing a second electrode and a second aqueous solution comprising a catholyte; and
a separator interposed between the first half-cell and the second half cell;
wherein less than 0.05% in concentration of the anolyte crosses over the separator to the second half-cell; and
wherein less than 0.05% in concentration of the catholyte crosses over the separator to the first half-cell.

2. The redox flow battery of claim 1, wherein the separator is a size exclusion membrane, an ion exchange membrane, an anion exchange membrane, or a cation exchange membrane.

3. The redox flow battery of claim 1, wherein less than 0.001% in concentration of the anolyte crosses over the separator to the second half-cell, and wherein less than 0.001% in concentration of the catholyte crosses over the separator to the first half-cell.

4. The redox flow battery of claim 1, wherein the compound has a Formula (I): 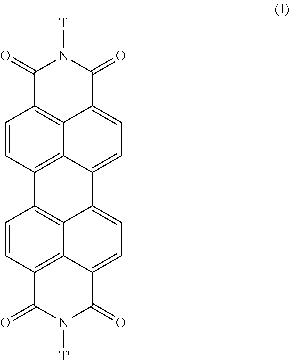
or a salt thereof, wherein:
T is -(L-G)ₙ-X;
T′ is H, (C₁-C₆)alkyl, or -(L-G)ₙ-X;
L is —(C₂-C₅)-alkyl optionally substituted with OH, OCH₃, halo 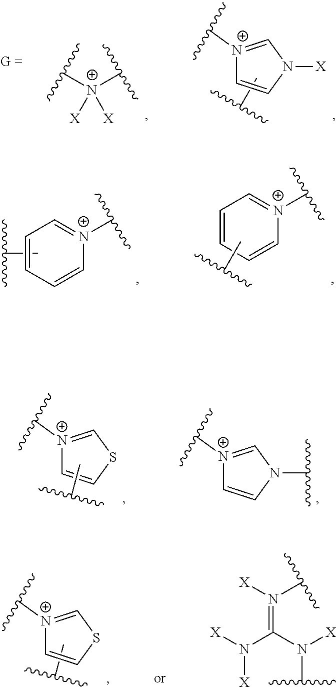
each X is independently H, —(C₁-C₁₀)alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
n=2 to 8; and
p=3 to 20.

5. The redox flow battery of claim 4, wherein T and T′ are each independently -(L-G)ₙ-X.

6. The redox flow battery of claim 4, wherein L is selected from the group consisting of: unsubstituted —(C₂-C₅)-alkyl, ethyl, and propyl.

7. The redox flow battery of claim 4, wherein n is 2, 3, or 4.

8. The redox flow battery of claim 4, wherein G is 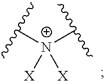
wherein X is H, methyl, —CH₂CH₂OH, or —(C₁-C₆)-alkyl.

9. The redox flow battery of claim 4, wherein the compound of Formula (I) is:

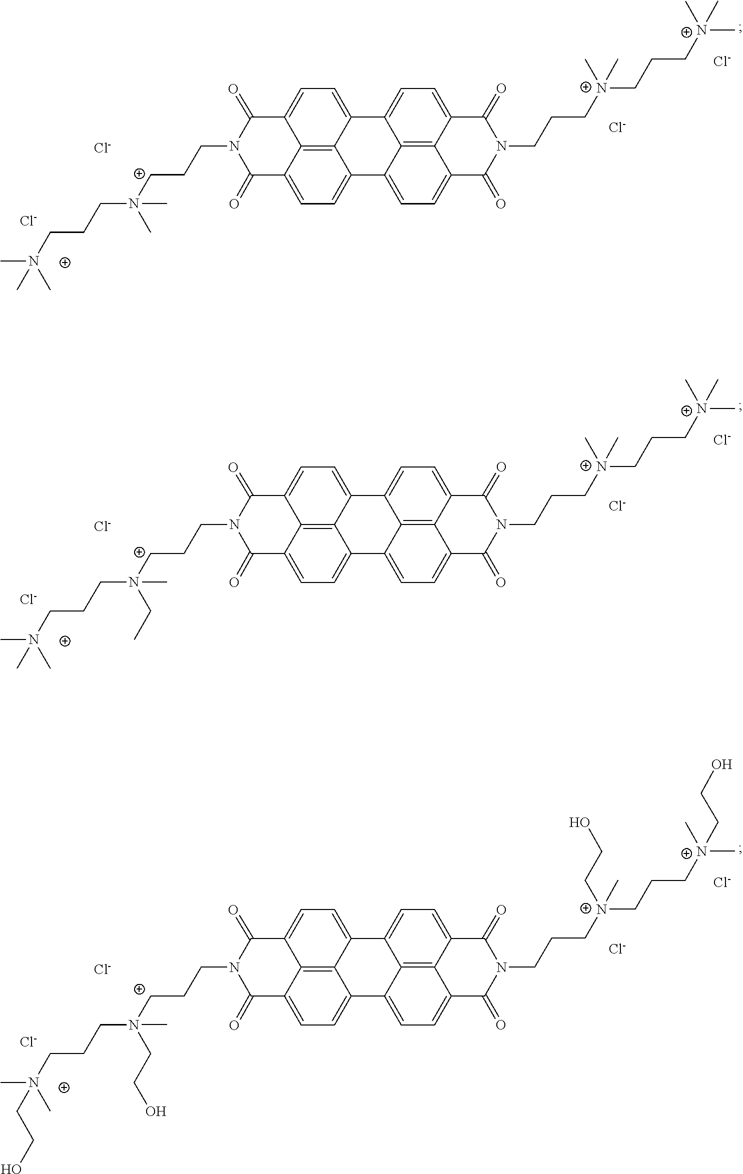

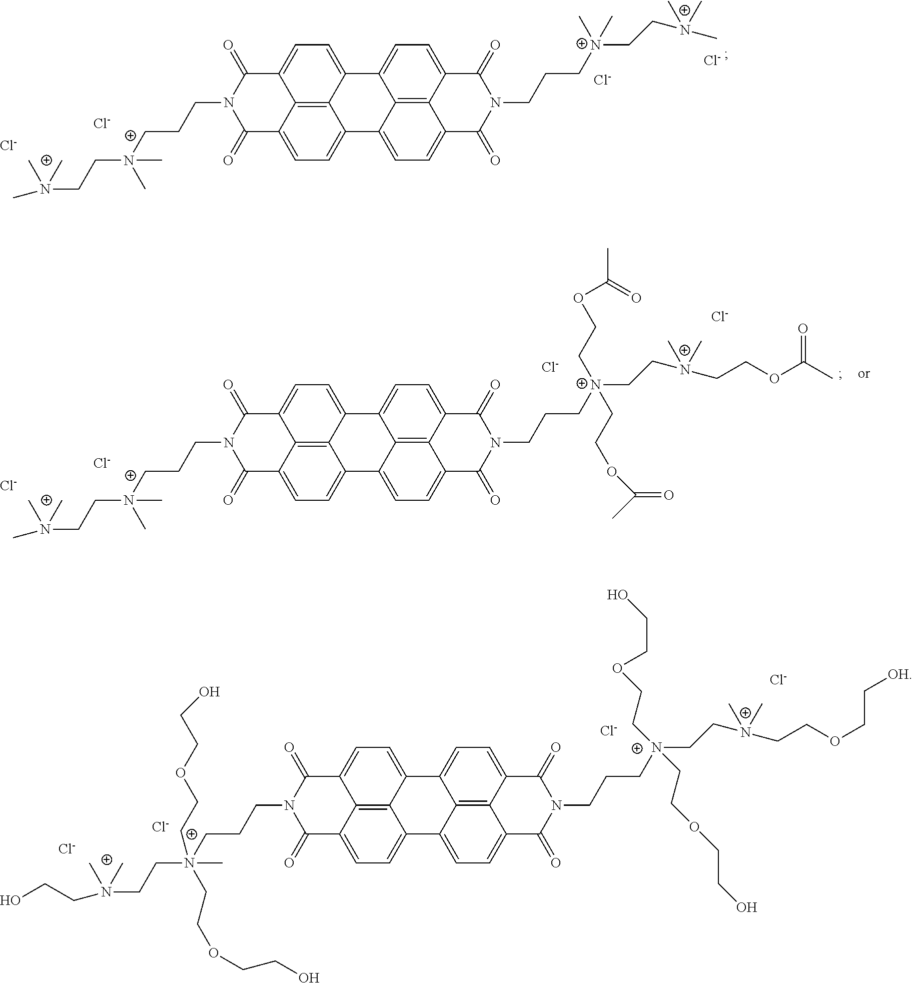

10. The redox flow battery of claim 1, wherein the compound has a Formula (III): 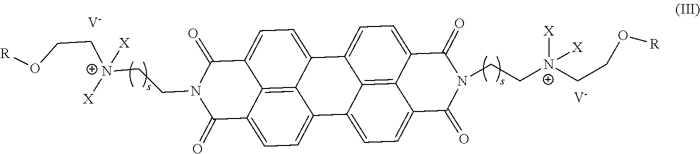
wherein:
each X is independently H, —(C₁-C₁₀)-alkyl, —(C₂-C₆)alkenyl, —(C₂-C₆)alkynyl, and —(C₁-C₆)alkoxy, each of which is unsubstituted or substituted with 1, 2, or 3 independently selected R¹ groups;
each R¹ is independently —OH, —O(C₁-C₆)-alkyl, —O(C₁-C₆)-alkyl-O(C₁-C₆)-alkyl, —O(C₁-C₆)-alkyl-O(C₁-C₆)-alkyl-O(C₁-C₆)alkyl, —[O(C₁-C₆)-alkyl]ₚ-O(C₁-C₆), —O(C═O)(C₁-C₆)alkyl, —O(C═O)O(C₁-C₆)alkyl, —O(C═O)OH, —O(C═O)NH₂, —O(C═O)NH(C₁-C₆)alkyl, O(C═O)N[(C₁-C₆)alkyl]₂, —NH(C═O)(C₁-C₆)alkyl, N(C₁-C₆)alkyl(C═O)(C₁-C₆)alkyl, halo, —CN, —NO₂, NH₂, NH(C₁-C₆)alkyl, and N[(C₁-C₆)alkyl]₂;
each s is independently 2 to 4;
each R is independently H, —CH₂OH, —CH₂CH₂OH, —CH₂CH₂OCH₂CH₂OH, or —CH₂CH₂OCH₂CH₂O(C₁-6)alkyl; and
each V⁻ is a counterion.

11. The redox flow battery of claim 10, wherein the compound of Formula (III) is:

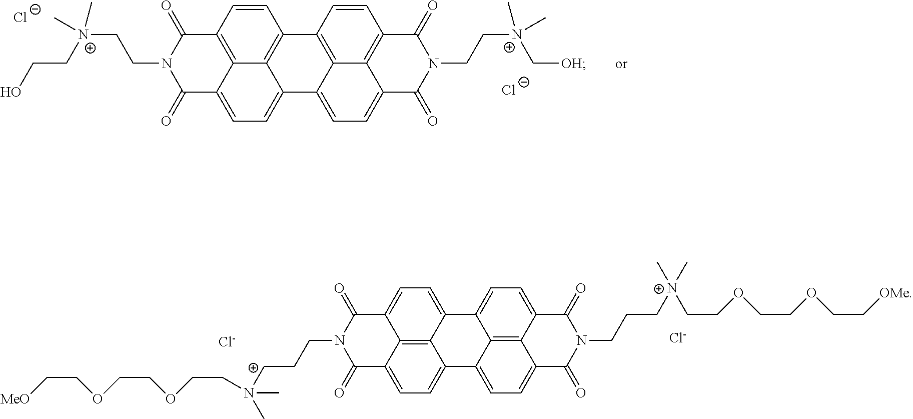

12. The redox flow battery of claim 1, wherein the compound has a Formula (IV): 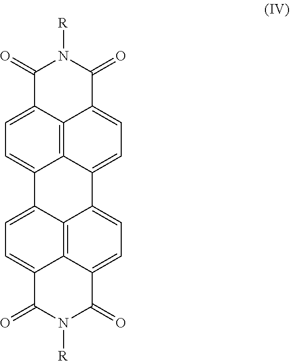
wherein
R is

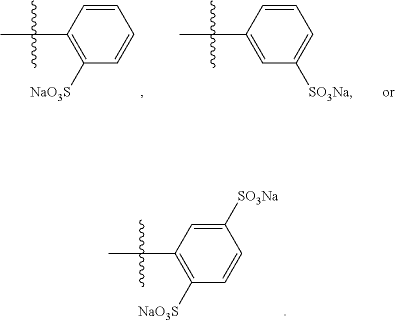

13. The redox flow battery of claim 1, wherein the compound has a Formula (V): 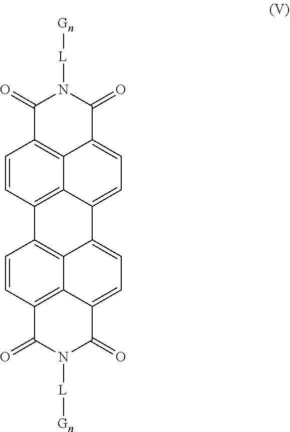
or a salt thereof, wherein
L is —(C₁-C₆)-alkyl;
each G is 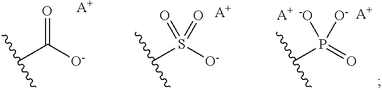
A is a cation; and
n=1 to 5.

14. The redox flow battery of claim 13, wherein L is substituted with OH, OCH₃, and halo; wherein each A is lithium, sodium, potassium, or ammonium.

15. The redox flow battery of claim 13, wherein L-Gₙ group has at least one chiral center.

16. The redox flow battery of claim 15, wherein the formula (V) has at least one stereoisomer.

17. The redox flow battery of claim 13, wherein the compound of Formula (V) is:

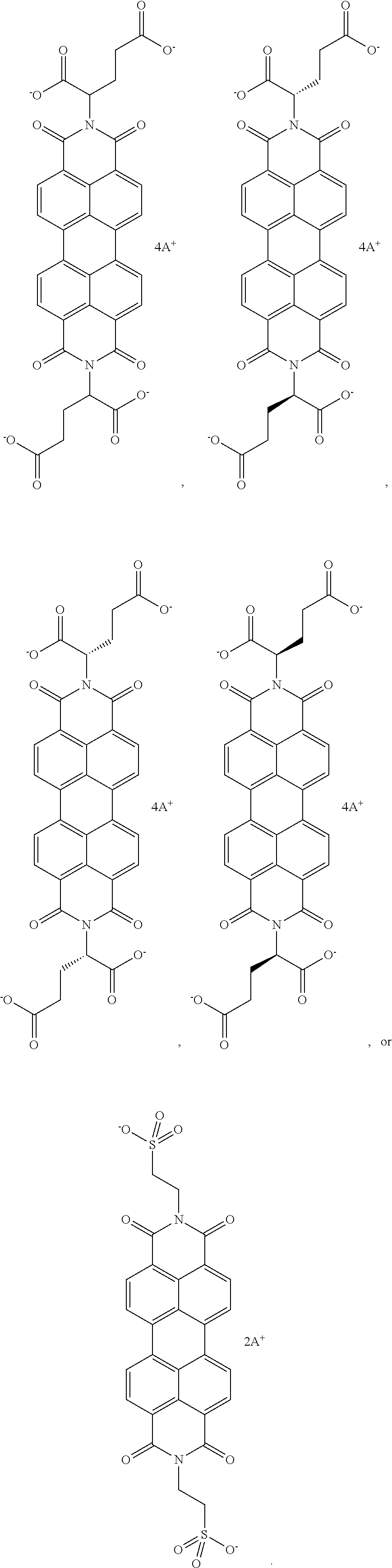

18. The redox flow battery of claim 17, wherein A is lithium, sodium, potassium, or ammonium.

19. The redox flow battery of claim 1, wherein the catholyte comprises a second compound with a ferrocene moisty.

20. The redox flow battery of claim 19, wherein the second compound has a formula selected from the group consisting of:

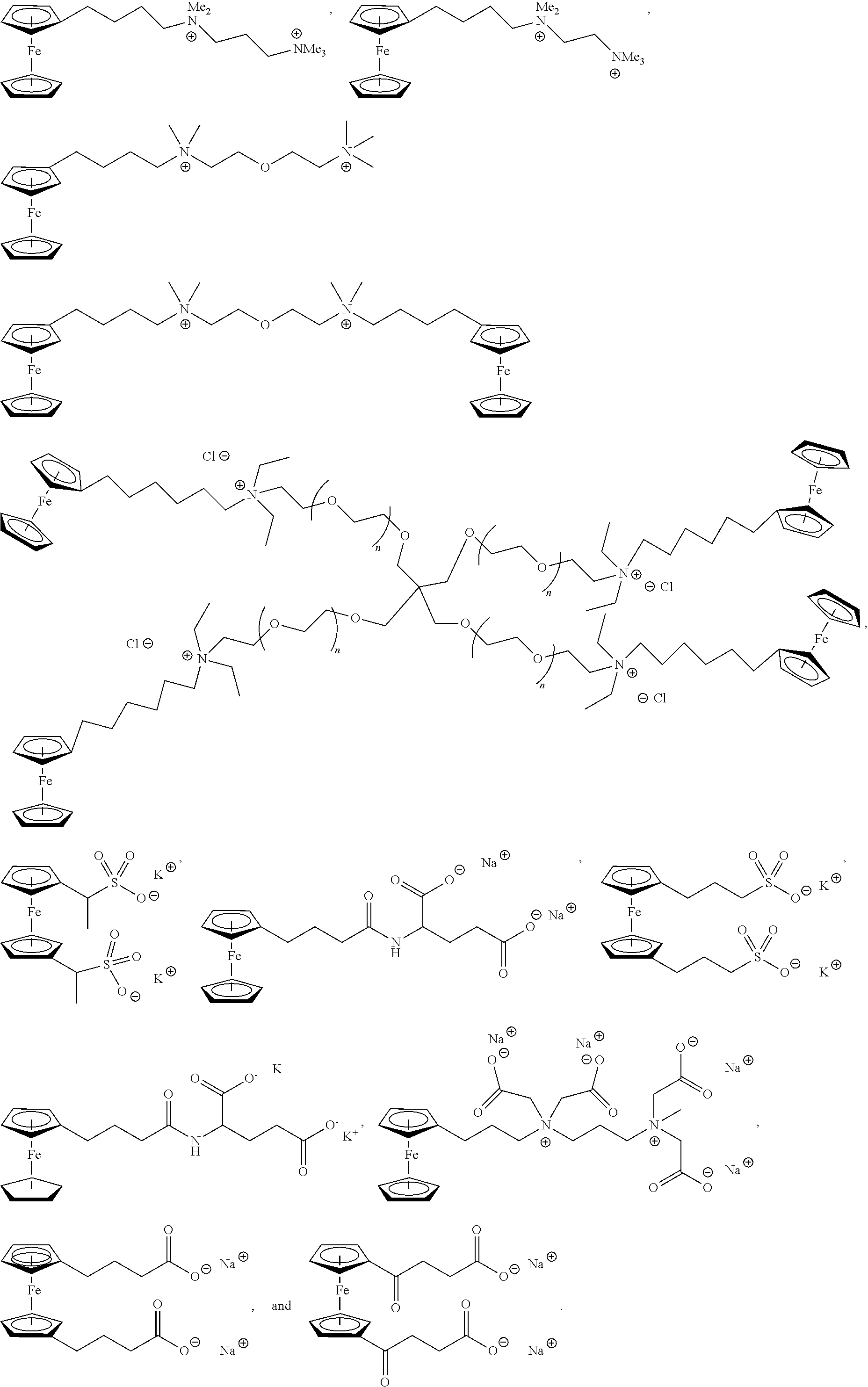

21. The redox flow battery of claim 19, wherein the second compound has a Formula (VI): 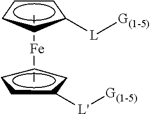
wherein:
L is —(C₁-C₁₀)-alkyl, —(C₁-C₆)-alkenyl, —(C1-C6)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl-(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
L′is —H, —(C₁-C₁₀)-alkyl, —(C₁-C₆)-alkenyl, —(C1-C6)-alkynyl, —(C₁-C₆)-alkyl-O(C₁-C₆)-alkyl, —(C₁-C₆)-alkyl-O—(C═O)—(C₁-C₆)alkyl, —(C₁-C₆)-alkyl-(C═O)—O—(C₁-C₆)alkyl, —(C₁-C₆)alkyl-NH—(C═O)(C₁-C₆)alkyl, —(C₁-C₆)alkyl-NR²—(C═O)(C₁-C₆)alkyl, —(C₁-C₆)alkyl-(C═O)—NH—(C₁-C₆)alkyl, —(C₁-C₆)alkyl-(C═O)—NR²—(C₁-C₆)alkyl, or —(C₁-C₁₀)-alkyl-aryl;
G is selected from the group consisting of 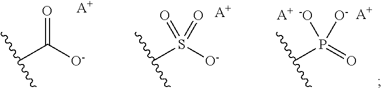
G is greater than or equal to 2;
A is Li, K, Na, or NH₄; and
R² is —(C₁-C₁₀)-alkyl, —(C₁-C₆)-alkenyl, —(C₁-C₆)-alkynyl, —(C₁-C₁₀)-alkyl-aryl, -aryl, or —(C═O)—(C₁-C₆)-alkyl.

22. The redox flow battery of claim 21, wherein L is substituted by at least one group selected from the group consisting of: G, —OH, —OCH₃, and -halo; wherein L′ is substituted at least one group selected from the group consisting of: G, —OH, —OCH₃, and -halo;
wherein R² is substituted by at least one G.

23. The redox flow battery of claim 21, wherein the compound of Formula (VI) is

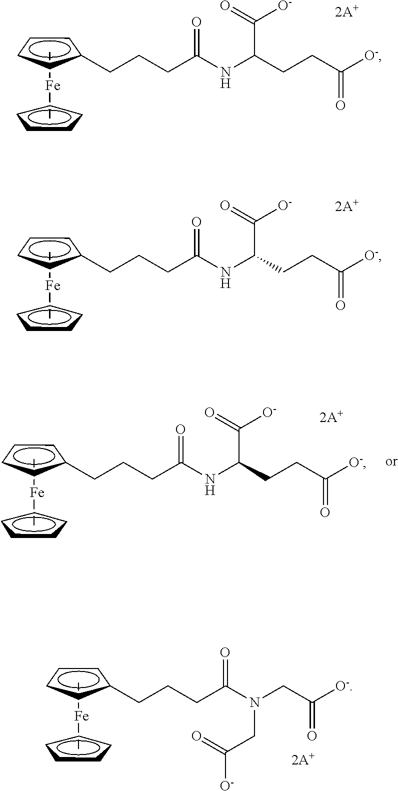

24. The redox flow battery of claim 1, wherein the anolyte is perylene diimide-diammonium-Cl₂ and the catholyte is ferrocene-diammonium-Cl₂.

25. The redox flow battery of claim 1, wherein the anolyte is perylene diimide-diammonium-Cl₂ and less than 0.0004% in concentration of the anolyte crosses over the separator to the second half-cell after cycling the redox flow battery for at least 90 days.

26. The redox flow battery of claim 1, wherein the catholyte is ferrocene-diammonium-Cl₂ and less than 0.02% in concentration of the catholyte crosses over the separator to the first half-cell after cycling the redox flow battery for at least 90 days.
